(19) United States
(12) Patent Application Publication
(10) Pub. No.: US 2023/0372993 A1
(43) Pub. Date: Nov. 23, 2023

(54) BITS AND METHODS OF MANUFACTURE AND USE THEREOF

(71) Applicant: DiversiTech Corporation, Duluth, GA (US)

(72) Inventors: Jonathan Sada, Lawrenceville, GA (US); Nolan Lunsford, Marietta, GA (US)

(21) Appl. No.: 18/031,340

(22) PCT Filed: Oct. 13, 2021
(86) PCT No.: PCT/US2021/054753

§ 371 Date: Apr. 11, 2023

Related U.S. Application Data
(60) Provisional application No. 63/090,994, filed on Oct. 13, 2020.

(51) Int. Cl. B21D 41/02

(52) U.S. Cl. CPC B21D 41/021; B21D 41/026; B33Y 80/00

(57) ABSTRACT

This disclosure enables various bits to widen (e.g., flare, swage) various open end portions (e.g., with a circular cross-section) of various tubes (e.g., a metal tube, an alloy tube, a copper tube, an aluminum tube) by engaging thereagainst.

### CROSS-REFERENCE TO RELATED PATENT APPLICATION

This patent application claims a benefit of priority to U.S. Provisional Patent Application 63/090,994 filed 13 Oct. 2020, which is incorporated by reference herein for all purposes.

### BACKGROUND

An open end portion (e.g., with a circular cross-section) of a tube (e.g., a copper tube, an aluminum tube) may need to be widened (e.g., flared, swaged). As such, a user may secure a bit to a power tool (e.g., an electric handheld drill, an electric handheld screwdriver), spin the bit via the power tool, and insert the bit, while the bit is spinning via the power tool, into the open end portion to widen the open end portion by engaging thereagainst. Although this technology may sometimes be useful, this technology still suffers from various drawbacks. For example, the bit may include excessive material. Likewise, the bit may not be configured for operations in tight spaces. Similarly, the bit may not be interchangeable with other bits.

### SUMMARY

Generally, this disclosure enables various bits to widen (e.g., flare, swage) various open end portions (e.g., with a circular cross-section) of various tubes (e.g., a metal tube, an alloy tube, a copper tube, an aluminum tube) by engaging thereagainst.

In an embodiment, a bit comprising: a shank configured to be spun; and a tip configured to widen an open end portion of a tube by engaging thereagainst when the shank is spinning and the tip is inserted into the open end portion.

In an embodiment, a method comprising: additively manufacturing a bit including a shank configured to be spun and a tip configured to widen an open end portion of a tube by engaging thereagainst when the shank is spinning and the tip is inserted into the open end portion.

In an embodiment, a method comprising: subtractively manufacturing a bit including a shank configured to be spun and a tip configured to widen an open end portion of a tube by engaging thereagainst when the shank is spinning and the tip is inserted into the open end portion.

In an embodiment, a method comprising: sending a bit to a user, wherein the bit includes a shank and a tip; and instructing the user to: spin the shank; and insert the tip into an open end portion of a tube while the shank is spinning such that the tip widens the open end portion by engaging thereagainst.

### DESCRIPTION OF DRAWINGS

FIG. 1 to FIG. 7 show a bit according to this disclosure.

FIG. 8 shows a container storing a set of bits arranged according to a set of sizes according to this disclosure.

FIG. 9 to FIG. 10 show how a bit is secured to a chuck of a drill according to this disclosure.

FIG. 11 to FIG. 12 show how a bit secured to a chuck of a drill is used to flare an open end of a tube according to this disclosure.

FIG. 13 to FIG. 19 show a bit according to this disclosure.

FIG. 20 shows a container storing a set of bits arranged according to a set of sizes according to this disclosure.

FIG. 21 to FIG. 22 show how a bit is secured to a chuck of a drill according to this disclosure.

FIG. 23 to FIG. 24 show how a bit secured to a chuck of a drill is used to swage an open end of a tube according to this disclosure.

FIG. 25 to FIG. 31 show a bit according to this disclosure.

FIG. 32 shows a container storing a set of bits arranged according to a set of sizes according to this disclosure.

FIG. 33 to FIG. 34 show how a bit is secured to a chuck of a drill according to this disclosure.

FIG. 35 to FIG. 36 show how a bit secured to a chuck of a drill is used to flare an open end of a tube according to this disclosure.

FIG. 37 to FIG. 43 show a bit according to this disclosure.

FIG. 44 shows a container storing a set of bits arranged according to a set of sizes according to this disclosure.

FIG. 45 to FIG. 46 show how a bit is secured to a chuck of a drill according to this disclosure.

FIG. 47 to FIG. 48 show how a bit secured to a chuck of a drill is used to swage an open end of a tube according to this disclosure.

FIG. 49 to FIG. 55 show a bit according to this disclosure.

FIG. 56 shows a container storing a set of bits arranged according to a set of sizes according to this disclosure.

FIG. 57 to FIG. 58 show how a bit is secured to a chuck of a drill according to this disclosure.

FIG. 59 to FIG. 60 show how a bit secured to a chuck of a drill is used to flare an open end of a tube according to this disclosure.

FIG. 61 to FIG. 67 show a bit according to this disclosure.

FIG. 68 shows a container storing a set of bits arranged according to a set of sizes according to this disclosure.

FIG. 69 to FIG. 70 show how a bit is secured to a chuck of a drill according to this disclosure.

FIG. 71 to FIG. 72 show how a bit secured to a chuck of a drill is used to swage an open end of a tube according to this disclosure.

FIG. 73 to FIG. 79 show a bit according to this disclosure.

FIG. 80 shows a container storing a set of bits arranged according to a set of sizes according to this disclosure.

FIG. 81 to FIG. 82 show how a bit is secured to a chuck of a drill according to this disclosure.

FIG. 83 to FIG. 84 show how a bit secured to a chuck of a drill is used to flare an open end of a tube according to this disclosure.

FIG. 85 to FIG. 91 show a bit according to this disclosure.

FIG. 92 shows a container storing a set of bits arranged according to a set of sizes according to this disclosure.

FIG. 93 to FIG. 94 show how a bit is secured to a chuck of a drill according to this disclosure.

FIG. 95 to FIG. 96 show how a bit secured to a chuck of a drill is used to swage an open end of a tube according to this disclosure.

FIG. 97 to FIG. 103 show a bit according to this disclosure.

FIG. 104 shows a container storing a set of bits arranged according to a set of sizes according to this disclosure.

FIG. 105 to FIG. 106 show how a bit is secured to a chuck of a drill according to this disclosure.

FIG. 107 to FIG. 108 show how a bit secured to a chuck of a drill is used to flare an open end of a tube according to this disclosure.

FIG. 109 to FIG. 115 show a bit according to this disclosure.

FIG. 116 shows a container storing a set of bits arranged according to a set of sizes according to this disclosure.

FIG. 117 to FIG. 118 show how a bit is secured to a chuck of a drill according to this disclosure.

FIG. 119 to FIG. 120 show how a bit secured to a chuck of a drill is used to swage an open end of a tube according to this disclosure.

FIG. 121 to FIG. 128 show a bit according to this disclosure.

FIG. 129 shows a container storing a set of bits arranged according to a set of sizes according to this disclosure.

FIG. 130 to FIG. 131 show how a bit is secured to a chuck of a drill according to this disclosure.

FIG. 132 to FIG. 133 show how a bit secured to a chuck of a drill is used to flare an open end of a tube according to this disclosure.

FIG. 134 to FIG. 141 show a bit according to this disclosure.

FIG. 142 shows a container storing a set of bits arranged according to a set of sizes according to this disclosure.

FIG. 143 to FIG. 144 show how a bit is secured to a chuck of a drill according to this disclosure.

FIG. 145 to FIG. 146 show how a bit secured to a chuck of a drill is used to swage an open end of a tube according to this disclosure.

FIG. 147 shows a bit having a shank with a varying cross-section or width according to this disclosure.

### DETAILED DESCRIPTION

Generally, this disclosure enables various bits to widen (e.g., flare, swage) various open end portions (e.g., with a circular cross-section) of various tubes (e.g., a metal tube, an alloy tube, a copper tube, an aluminum tube) by engaging thereagainst. For example, a bit may comprise: a shank configured to be spun; and a tip configured to widen an open end portion of a tube by engaging thereagainst when the shank is spinning and the tip is inserted into the open end portion. Likewise, a method may comprise: sending (e.g., in a package via a courier or a postal service) a bit to a user, wherein the bit includes a shank and a tip; and instructing the user to: spin the shank; and insert the tip into an open end portion of a tube while the shank is spinning such that the tip widens the open end portion by engaging thereagainst. However, note that this disclosure may be embodied in many different forms and should not be construed as necessarily being limited to various embodiments disclosed herein. Rather, these embodiments are provided so that this disclosure is thorough and complete, and fully conveys various concepts of this disclosure to skilled artisans.

Note that various terminology used herein can imply direct or indirect, full or partial, temporary or permanent, action or inaction. For example, when an element is referred to as being “on,” “connected,” or “coupled” to another element, then the element can be directly on, connected, or coupled to another element or intervening elements can be present, including indirect or direct variants. In contrast, when an element is referred to as being “directly connected” or “directly coupled” to another element, then there are no intervening elements present.

As used herein, various singular forms “a,” “an” and “the” are intended to include various plural (e.g., two, three, four) forms as well, unless specific context clearly indicates otherwise.

As used herein, various presence verbs “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

As used herein, unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized or overly formal sense unless expressly so defined herein.

As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/−10% variation from a nominal value/term. Such variation is always included in any given value/term provided herein, whether or not such variation is specifically referred thereto.

Features described with respect to certain embodiments may be combined in or with various some embodiments in any permutational or combinatory manner. Different aspects or elements of example embodiments, as disclosed herein, may be combined in a similar manner.

Although the terms first, second, can be used herein to describe various elements, components, regions, layers, or sections, these elements, components, regions, layers, or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

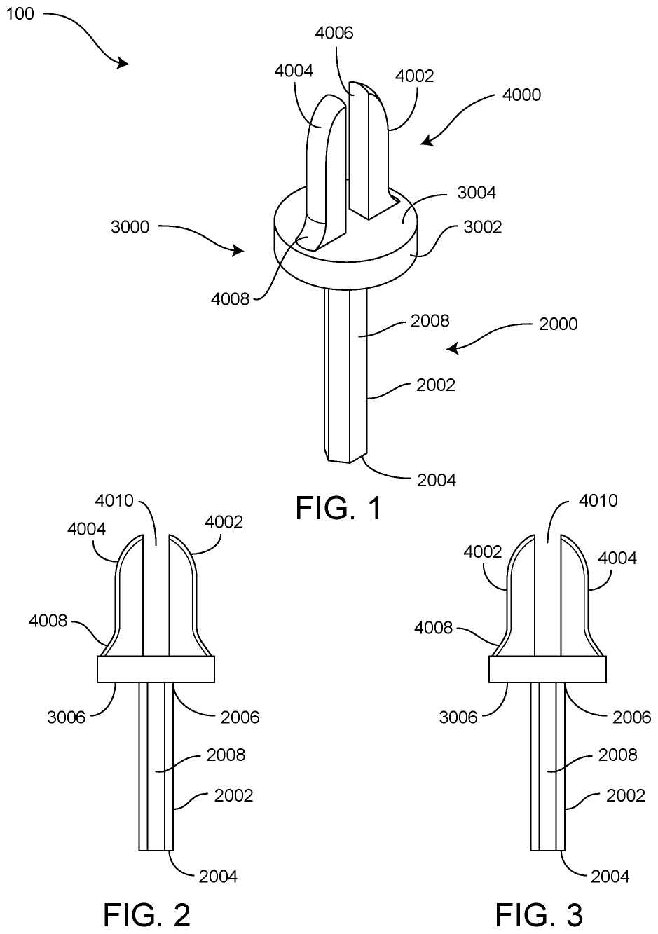

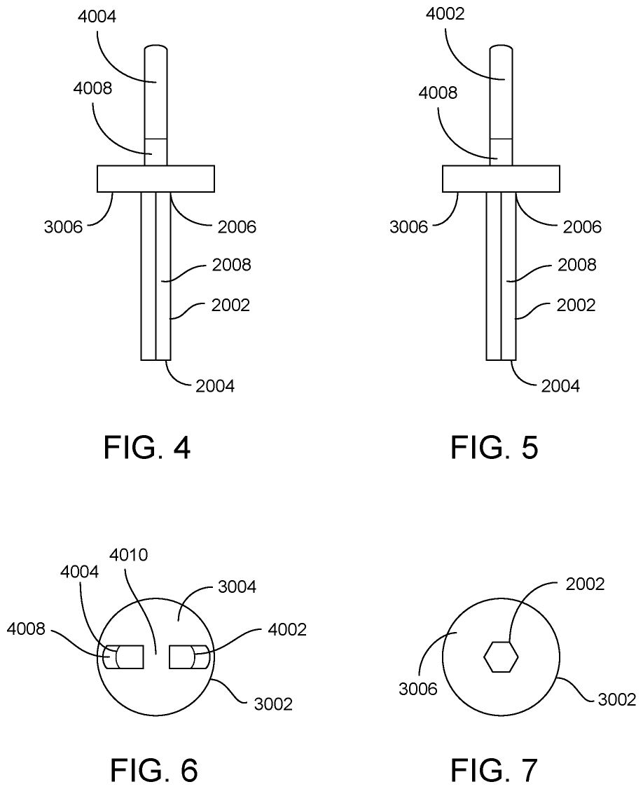

FIG. 1 to FIG. 7 show a bit according to this disclosure. In particular, a bit 100 includes a shank 2000 configured to be spun and a tip 4000 configured to widen (e.g., flare, swage) an open end portion (e.g., with a circular cross-section) of a tube (e.g., a metal tube, an alloy tube, an aluminum tube, a copper tube) by engaging thereagainst when the shank 2000 is spinning and the tip 4000 is inserted into the open end portion, as disclosed herein. The bit 100 includes a stopper 3000, but such inclusion is optional and the stopper 3000 may be omitted here and in any embodiments, as disclosed herein. For example, the tip 4000 can extend from the shank 2000.

The shank 2000 includes a bar 2002. The bar 2002 is internally solid, but can be internally hollow. The bar 2002 includes a metal (e.g., iron) or an alloy (e.g., stainless steel), but can include other materials (e.g., plastic, rubber). The bar 2002 extends rectilinearly, but this extension can vary (e.g., arcuate, sinusoidal).

The bar 2002 includes an end portion 2004 and an end portion 2006. The bar 2002 includes an outer surface 2008 spanning between the end portion 2004 and the end portion 2006. The outer surface 2008 enables the bar 2002 to have a hexagonal cross-section, although other shaping is possible (e.g., a polygon, a pentagon, a triangle, a trapezoid, a rectangle, a square, an oval, a circle, a pentagram, a teardrop). The outer surface 2008 has a uniform cross-section or width, but this configuration can vary (e.g., non-uniform cross-section or width).

The stopper 3000 (e.g., a disc, a set of radially extending bars) includes a body 3002, an outer surface 3004, and an outer surface 3006. The end portion 2006 is monolithic with the outer surface 3006, although this is optional. For example, the end portion 2006 can be assembled with the outer surface 3006 (e.g., mating, interlocking, fastening, adhering, ball-and-detent). For example, the bar 2002 may be positionally fixed to the stopper 3000 relative to the stopper 3000 or the bar 2002 may be movably fixed to the stopper 3000 relative to the stopper 3000 (e.g., pivoting, tilting). Likewise, when the stopper 3000 is omitted, then a similar configuration can be applied to the tip 4000. The outer surface 3006 is perpendicular to the bar 2002, although this is optional. For example, the outer surface 3006 can be non-perpendicular to the bar 2002. The outer surface 3006 faces or is exposed to the outer surface 2008. The outer surface 3004 faces or is exposed to the tip 4000.

The body 3002 is internally solid, but can be internally hollow. The body 3002 includes a metal (e.g., iron) or an alloy (e.g., stainless steel), but can include other materials (e.g., plastic, rubber). The body 3002 has a circular disc-shape, but this shaping can vary, whether a disc or not a disc. For example, the body 3002 may be shaped as a polygon, a pentagon, a triangle, a trapezoid, a rectangle, a square, an oval, a circle, a pentagram, a teardrop, or other shapes, whether a disc or not a disc. For example, when the body 3002 has a corner (e.g., a polygon, a rectangle, a square, a teardrop, a trapezoid, a pentagram), then the body 3002 may minimize or avoid rolling when resting on a surface that is inclined (e.g., between about 10 degrees and about 30 degrees). For example, the body 3002 may have a non-disc shape. For example, the body 3002 may include a set of bars radially extending from the outer surface 2008 in a set of directions (e.g., according to a clock dial), which may be opposite each other (e.g., in a sunray-like manner). For example, the set of bars can extend at 3 o'clock and 9 o'clock from the outer surface 2008, which may allow for stacking a set of bits 100 one-on-top of another, or minimize or avoid rolling when resting on a surface that is inclined (e.g., between about 10 degrees and about 30 degrees). For example, the set of bars can extend at 12 o'clock, 3 o'clock, 6 o'clock, and 9 o'clock from the outer surface 2008, which minimize or avoid rolling when resting on a surface that is inclined (e.g., between about 10 degrees and about 30 degrees). For example, the set of bars can extend from the outer surface 2008 in diametrically opposing directions.

The tip 4000 includes a set of projections 4002 (e.g., a first column, a second column). Although a pair of projections 4002 is shown, this is not limiting. For example, there may be three, four, five, six, or more projections 4002, which may improve (e.g., quicken) widening (e.g., flaring, swaging) of the open end portion of the tube due to a presence of a large surface area engaging with the open end portion, as disclosed herein. For example, the set of projections 4002 may be arranged equilaterally (e.g., 120 degrees apart from each other), according to a clock dial (e.g., 3 o'clock, 6 o'clock, 9 o'clock, 12 o'clock), according to polygonal shape (e.g., at vertices or corners thereof), or in other ways.

Each of the projections 4002 extends away from the shank 200 and the outer surface 3004 when the stopper 3000 present. As shown in FIGS. 1-7, each of the projections 4002 extends away from the outer surface 3004 in a cantilevered manner, although non-cantilevered manner is possible. Each of the projections 4002 is internally solid, but can be internally hollow. Each of the projections 4002 includes a metal (e.g., iron) or an alloy (e.g., stainless steel), but can include other materials (e.g., plastic, rubber).

Each of the projections 4002 includes an outer surface 4004 and an inner surface 4006. The set of projections 4002 is positioned such that the projections 4002 are spaced apart from each other such that an air gap 4010 is formed therebetween. The inner surfaces 4006 are exposed to each other and face each other such that the air gap 4010 extends between the inner surfaces 4006. The inner surfaces 4006 are smooth, but can be rough. The inner surfaces 4006 extend rectilinear and perpendicular to the outer surface 3006, but this can vary (e.g., non-rectilinear or non-perpendicular). The shank 2002 has an axis of rotation or an axis of symmetry that is co-aligned with the axis of rotation or the axis of symmetry, although this is not required (e.g., not co-aligned with the axis of rotation or the axis of symmetry). As shown, the air gap 4010 is U-shaped as defined via the inner surfaces 4006 and the outer surface 3004, but this is not required and other shapes are possible (e.g., a C-shape, a Y-shape). For example, when the stopper 3000 is absent, then the shank 2000 and the projections 4002 may form a Y-shape to function, as disclosed herein.

Although the air gap 4010 is shown to extend from the outer surface 3004 to each apex of each projection 4002, this is not required and the air gap 4010 may extend less than that height. For example, the air gap 4010 may extend up to ½ way down from the apex of each projection 4002, with the remaining area being filled with solid or hollow block of material. Note that other amount of extension of the air gap 4010 are possible (e.g., up to ⅕, ⅖, ⅗, ⅘, ⅓, ⅔), which may be technologically beneficial in terms of reinforcement of the projections 4002. Further, there can be a reinforcement piece spanning or bridging between the projections 4002, whether the reinforcement piece is parallel or not parallel to the outer surface 3002 or horizontal plane. For example, the reinforcement piece can be horizontal or diagonal between the projections 4002.

The air gap 4010 may provide various technological advantages. For example, the air gap 4010 may avoid using excessive material, which may reduce manufacturing cost and increase manufacturing speed. Likewise, the air gap 4010 may allow the bit 100 to be used on concentric nested tubes (e.g., widening of open end portions between the concentric nested tubes).

The shank 2000 extends from the stopper 3000 by having the end 2006 extend from the outer surface 3006 (e.g., monolithic, assembly). The projections 4002 extend from the stopper 3000 by extending from the outer surface 3004 such that the stopper 3000 (e.g., the body 3002) extends between the air gap 4010 and the shank 2000. Each of the outer surfaces 4004 includes a sloped portion 4008 (e.g., arcuate, curving) merging into the stopper 3000 (e.g., the outer surface 3004). The sloped portions 4008 extend (e.g., incline, slope, curve) away from each other (e.g., in opposite directions) such that the air gap 4010 extends therebetween and the tip 4000 can widen the open end portion of the tube by flaring until the stopper 3000 contacts the tube, as disclosed herein. The stopper 3000 may extend past the sloped portions 4008 to contact the open end portion when flaring, which may enable stopping such flaring.

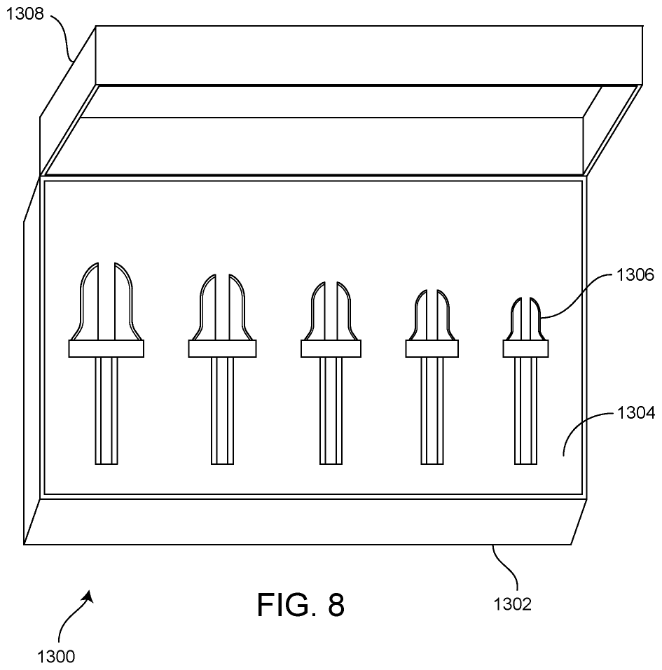

FIG. 8 shows a container storing a set of bits arranged according to a set of sizes according to this disclosure. In particular, a package 1300 includes a container 1302 (e.g., a box) containing a volume of resilient material 1304 (e.g. a packing foam) with a set of cutouts 1306 enclosing a set of bits 100 arranged according to a set of sizes where each stopper 3000 and each tip 4000 decreases in size (e.g., height, width). The set of bits 100 includes five units that differ in size, but this can vary more or less, as needed. The package 1300 includes a lid 1308 pivotally secured to the container 1302 such that the lid 1308 pivots between an open state and a closed state to grant or deny physical access to the set of bits 100. The lid 1308 may include transparent or translucent material to grant visual access through the lid 1308 to determine whether all or which bit 100 from the set of bits 100 is present or absent.

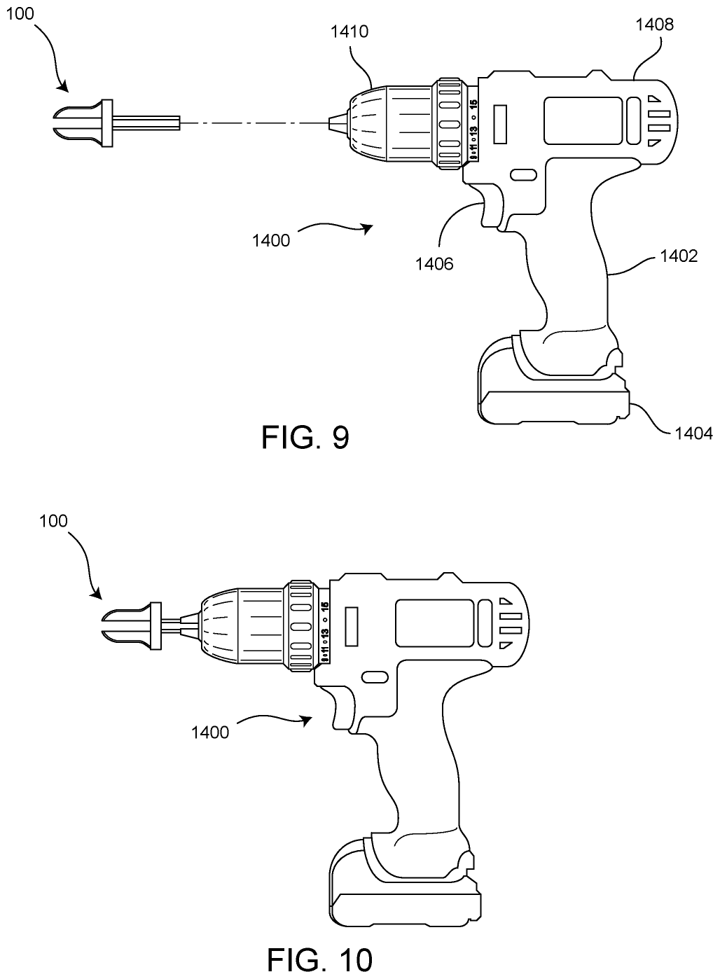

FIG. 9 to FIG. 10 show how a bit is secured to a chuck of a drill according to this disclosure. In particular, a power tool 1400 (e.g., an electric handheld drill, an electric handheld screwdriver) includes a handle 1402, a battery 1404 (e.g., lithium), a trigger 1406, a barrel 1408, and a chuck 1410. The battery 1404, which can be rechargeable, is secured to the handle 1402, which can be detachably. The trigger 1406 is pressable towards the handle 1402 and releasable away from the handle 1402. The barrel 1408 contains an electric motor (e.g., brushed, brushless) powered by the battery 1404 through the handle 1402 and activatable or de-activatable by pressing or releasing the trigger 1406. The chuck 1410 has an axis of rotation or an axis of symmetry. The chuck 1410 is secured to the barrel 1408. The chuck 1410 is mechanically coupled to the electric motor to spin the bit 100 that is inserted thereto when the electric motor is powered from the battery 1404. For example, such spin can include rate of at least 1800 revolutions per minute (RPM) and 500 watts for a corded electric and at least 1800 RPM and 18 volts for an electric cordless drill.

To secure the bit 100 to the drill 1400 or vice versa, the chuck 1410 is opened and the shank 2000 is inserted into the chuck 1410 or vice versa such that the stopper 3000 faces or is exposed to the chuck 1410 outside the chuck 1410, while the tip 4000 remains outside the chuck 1410 and the axis of symmetry or the axis of rotation of the shank 2000 is co-aligned with the axis of symmetry or the axis of rotation of the chuck 1410. Then, the chuck 1410 is closed (e.g., tightened) such that the chuck 1410 securely grasps the shank 2000 and can spin the shank 2000, while the stopper 3000 faces the chuck 1410 outside the chuck 1410 and the tip 4000 remains outside the chuck.

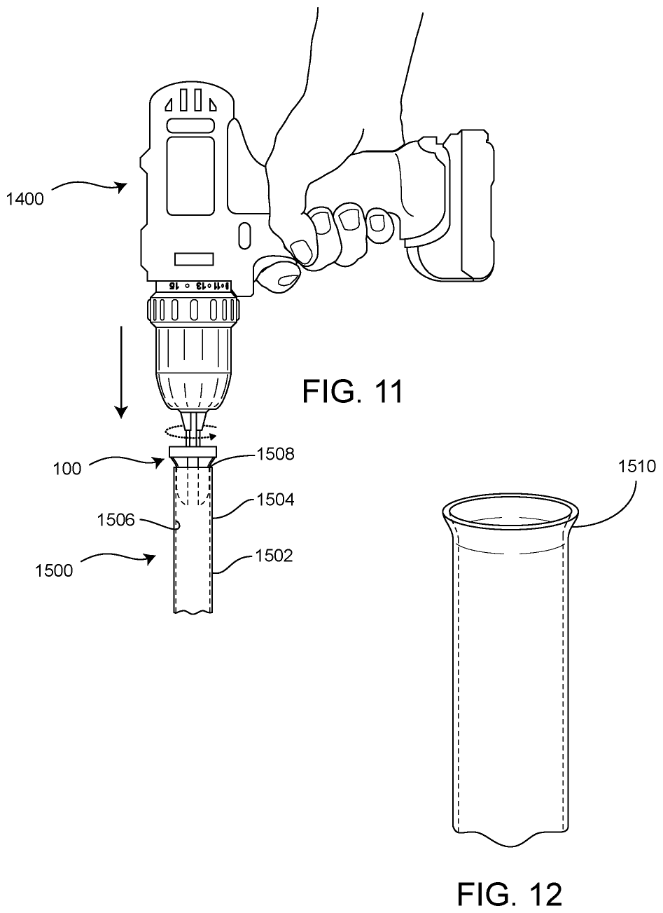

FIG. 11 to FIG. 12 show how a bit secured to a chuck of a drill is used to flare an open end of a tube according to this disclosure. In particular, a tube 1500 includes a body 1502 (e.g., copper, aluminum), an outer surface 1504, an inner surface 1506, and an open end portion 1508 (e.g., with a circular cross-section). For example, the body 1502 may include copper, aluminum, or another material that may become malleable when heated by rotational friction. As such, to widen (e.g., flare) the open end portion 1508, a method may include sending the bit 100 to a user or otherwise allowing the user to physically access the bit 100, while the bit 100 includes the shank 2000 and the tip 4000, as disclosed herein. The method may include instructing the user (e.g., a sheet of paper, a website) to: spin the shank 2000 and insert the tip 4000 into the open end portion 1508 of the tube 1500 while the shank 2000 is spinning such that the tip 4000 widens the open end portion 1508 by engaging thereagainst.

The shank 2000 may be spun by the power tool 1400, when the battery 1404 powers the electric motor based on the trigger 1406 being activated and the bar 2002 being correspondingly held by the chuck 1410 and being spun by the chuck 1410. Once the bar 2002 is spinning, then the tip 4000 is correspondingly spinning. Then, the projections 4002 are simultaneously inserted into the open end portion 1508 such that the outer surface 3004 faces the open end portion 1508 and the outer surfaces 4004 are engaging or contacting the inner surface 1506 during spinning, thereby creating heat via friction and causing the open end portion 1508 to become malleable. Then, once the sloped portions 4008 progressively or gradually enter the open end portion 1508, then the sloped portions 4008 progressively or gradually widen (e.g., flare) the open end portion 1508 to appear as an open end portion 1510 due to the open end portion 1508 being malleable via heat at that time, as formed via the projections 4002 spinning within the open end portion 1508. This insertion continues until the stopper 3000 (e.g., the outer surface 3002) contacts the open end portion 1510, thereby preventing (e.g., stopping) the tip 4000 from being inserted further into the tube 1500 (e.g., when the stopper 3000 extends past the sloped portions 4008). Then, the user may deactivate the trigger 1406 to stop the bar 2002 from spinning via the chuck 1410, which stops the projections 4002 from spinning within the open end portion 1510, and pull the power tool 1400 away from the tube 1500 such that the projections 4002 exit the open end portion 1510. Once the open end portion 1510 is cooled (e.g., air cooled, inserted into cold water), then the open end portion 1510 may be used for other tasks (e.g., receive a nut or another tube).

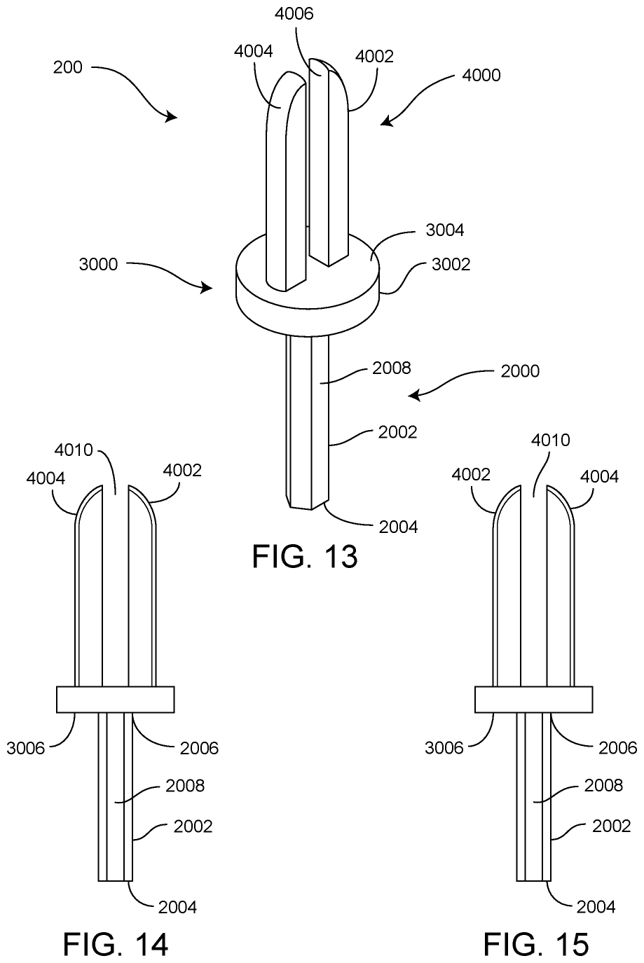

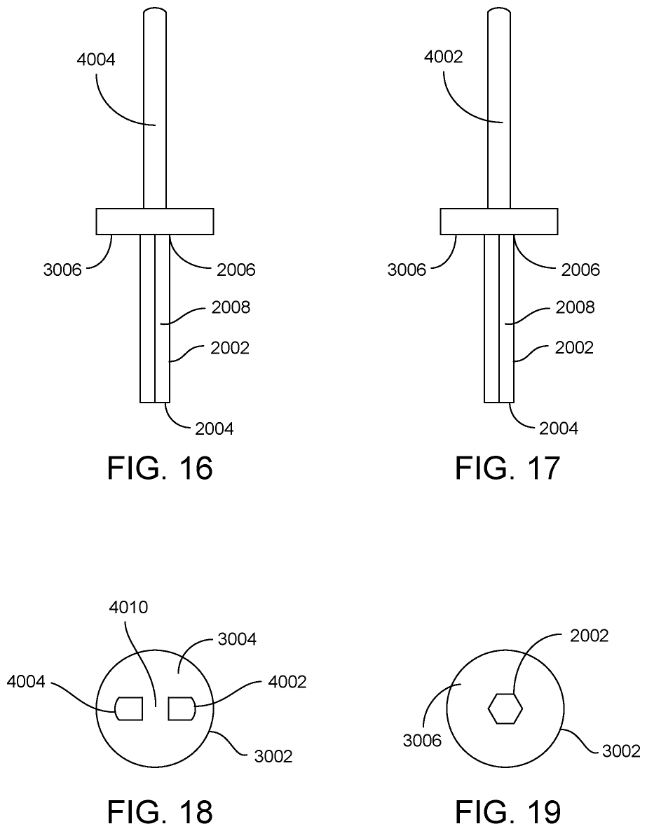

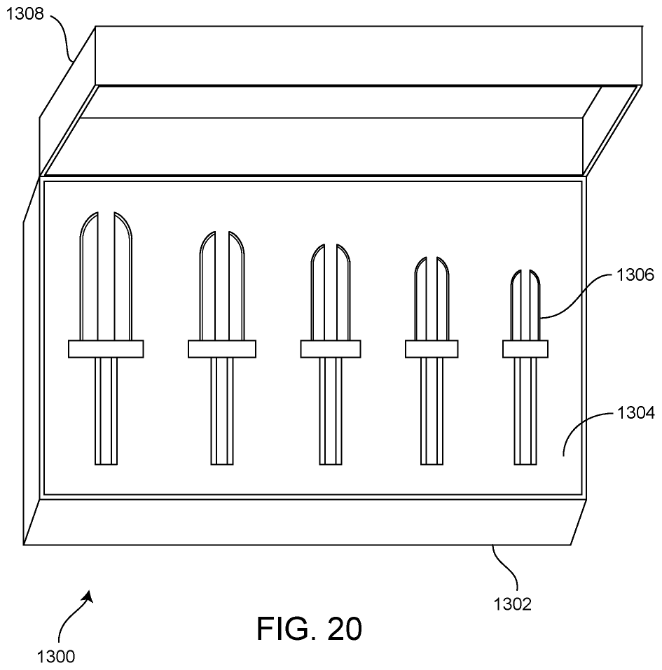

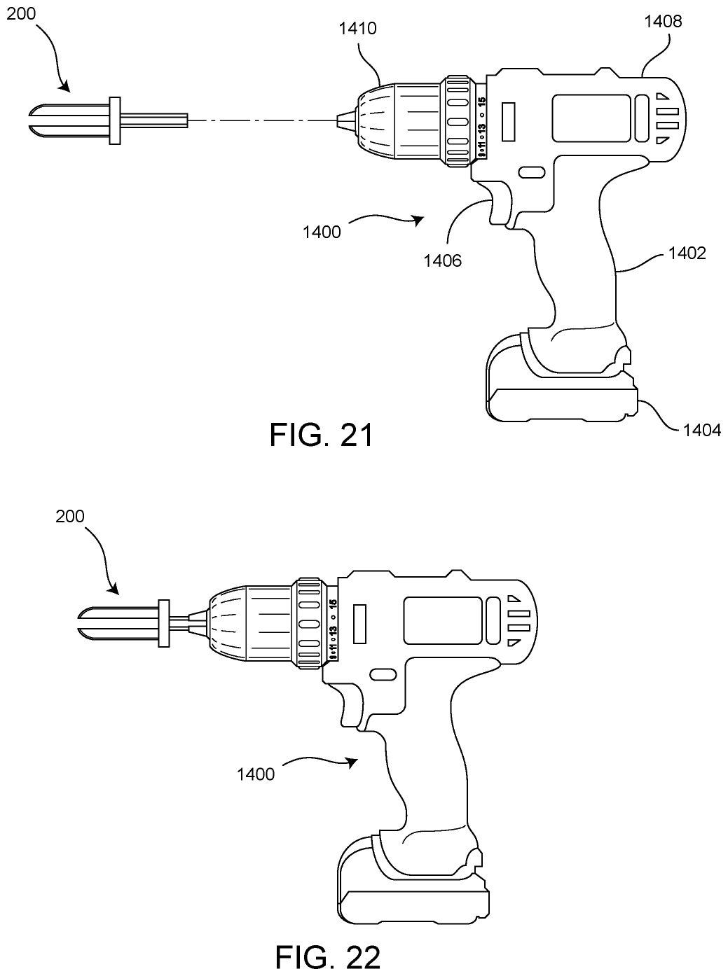

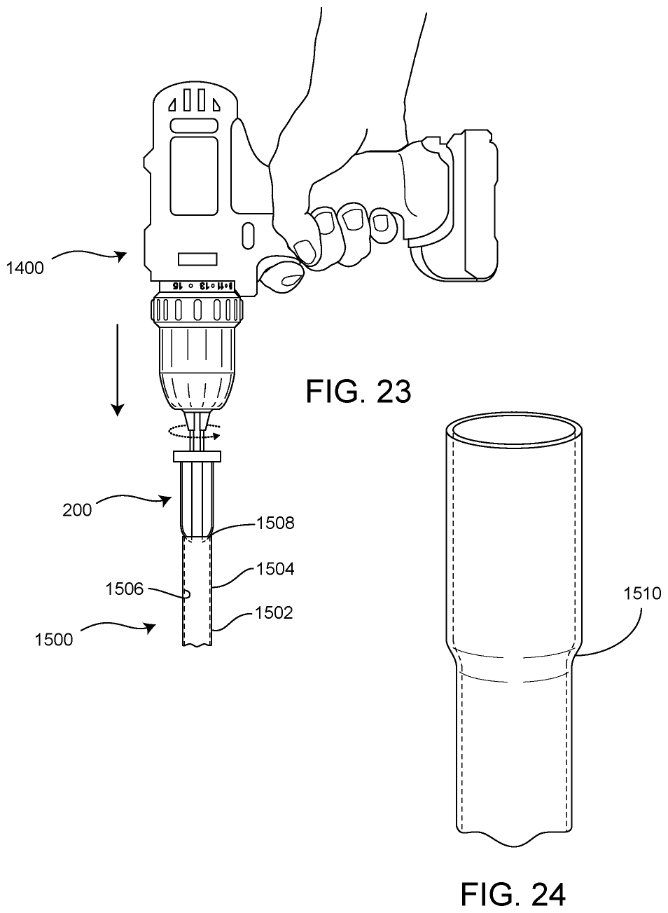

FIG. 13 to FIG. 19 show a bit according to this disclosure. FIG. 20 shows a container storing a set of bits arranged according to a set of sizes according to this disclosure. FIG. 21 to FIG. 22 show how a bit is secured to a chuck of a drill according to this disclosure. FIG. 23 to FIG. 24 show how a bit secured to a chuck of a drill is used to swage an open end of a tube according to this disclosure. In particular, a bit 200 is structurally and functionally similar to the prior bits, manufactured similar to the prior bits, packaged similar to the prior bits, and operated similar to the prior bits. However, unlike the prior bits, the bit 200 does not have the sloped portions 4008. As such, the bit 200 does not widen the open end portion 1508 by flaring. Instead, the bit 200 widens the open end portion 1508 by swaging. This occurs based on each of the projections 4002 having a rectilinear portion (e.g., a flat portion, a planar portion) terminating at the stopper 3000 when the stopper 3000 is present or at the shank 2000. The rectilinear portions extend parallel to each other such that the air gap 4010 extends therebetween and the tip 4000 (e.g., the projections 4002) widens the open end portion 1508 of the tube by swaging the open end portion 1508 to appear as the open end portion 1510 until the stopper 3000 (e.g., the outer surface 3004) contacts the tube 1500 (e.g., the open end portion 1510). As such, since the sloped portions 4008 are absent, the projections 4002 widen (e.g., swage) the open end portion 1508 to appear as the open end portion 1510.

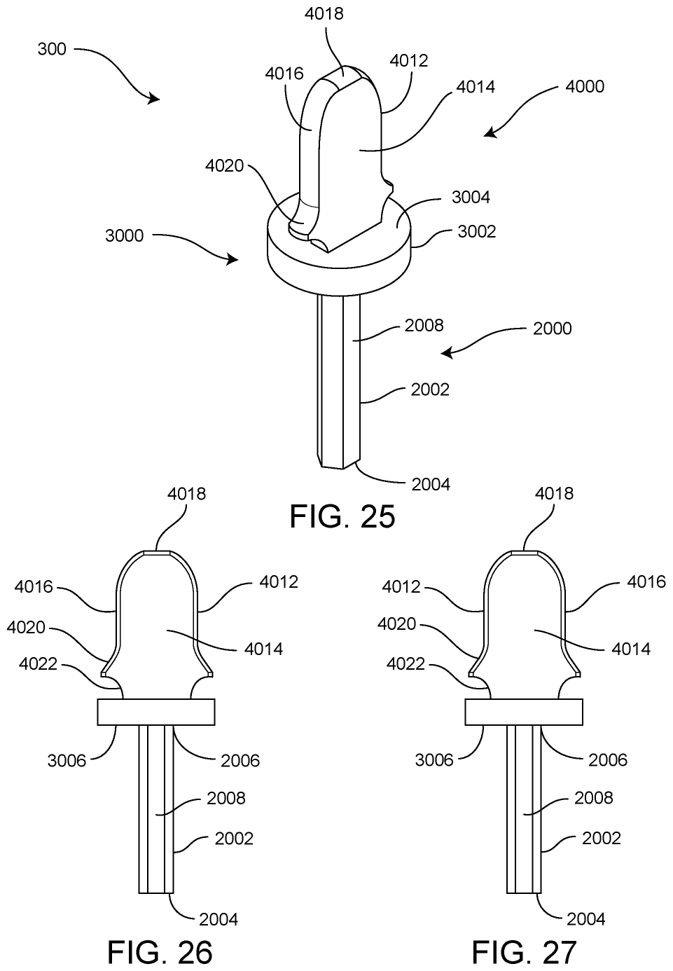

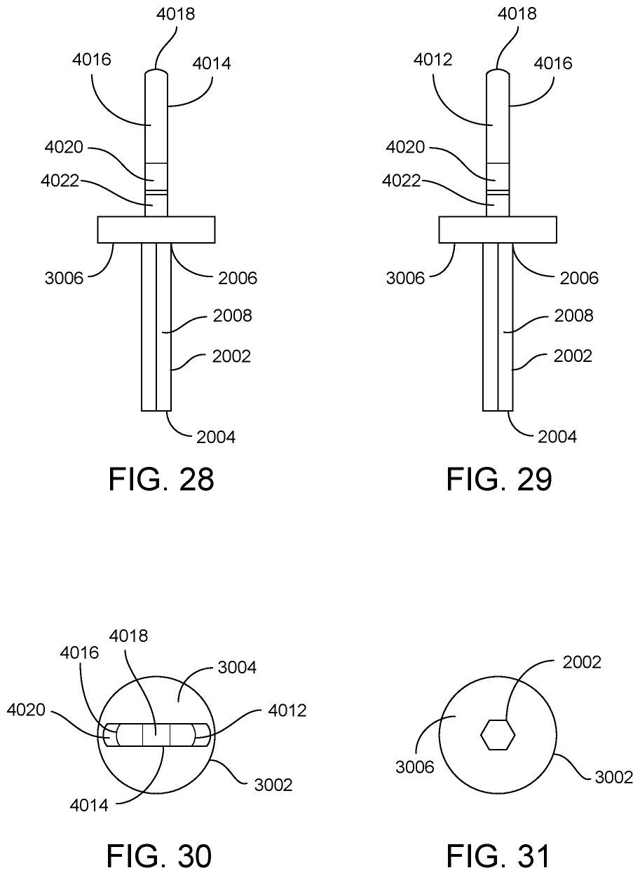

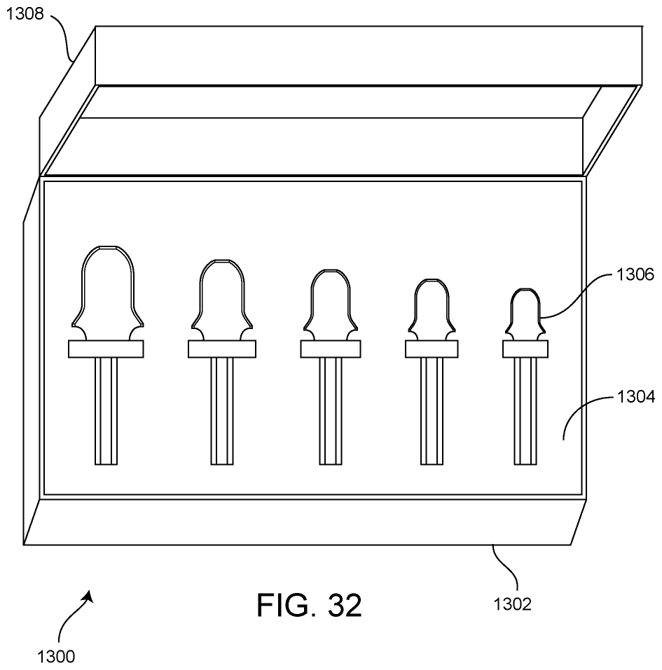

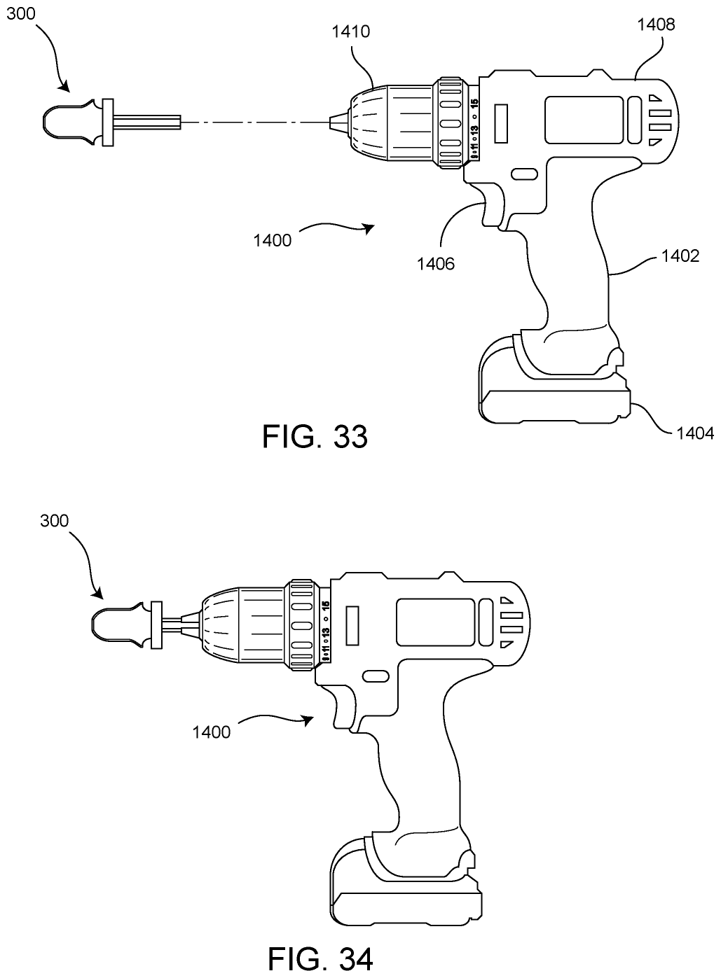

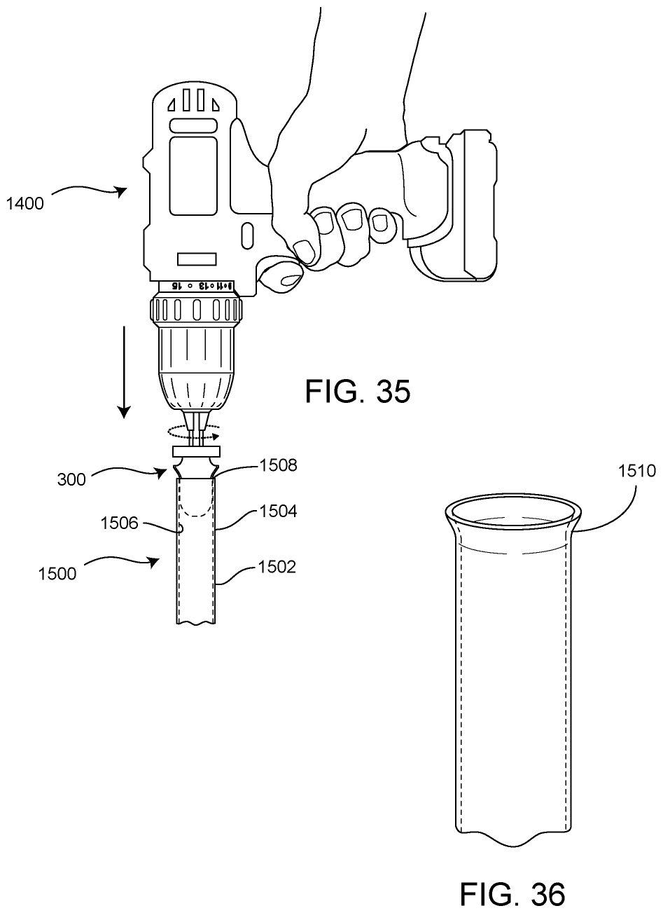

FIG. 25 to FIG. 31 show a bit according to this disclosure. FIG. 32 shows a container storing a set of bits arranged according to a set of sizes according to this disclosure. FIG. 33 to FIG. 34 show how a bit is secured to a chuck of a drill according to this disclosure. FIG. 35 to FIG. 36 show how a bit secured to a chuck of a drill is used to flare an open end of a tube according to this disclosure. In particular, a bit 300 is structurally and functionally similar to the prior bits, manufactured similar to the prior bits, packaged similar to the prior bits, and operated similar to the prior bits. However, the bit 300 differs from the prior bits in that the tip 4000 is structured differently to include a plate 4012 having a pair of faces 4014, a pair of outer surfaces 4016, an apex 4018, a pair of outwardly extending portions 4020, a pair of inwardly extending portions 4022 respectfully starting where the outwardly extending portions 4020 terminate. The stopper 3000 may extend past the pair of outwardly extending portions 4020 to contact the open end portion 1510 when flaring, which may enable stopping such flaring.

The pair of inwardly extending portions 4022 terminate at the stopper 3000 (e.g., the outer surface 3004) when the stopper 3000 is present or at the shank 2000 (e.g., the end portion 2006) when the stopper 3000 is absent. For example, the pair of inwardly extending portions 4022 may merge into the shank 2000 (e.g., the end portion 2006). The pair of inwardly extending portions 4022 may provide various technological advantages. For example, the pair of inwardly extending portions 4022 enable the outwardly extending portions 4020 (and the outer surfaces 4016) to be at a standoff distance further away from the power tool 1500, which may be useful when working tight spaces. Note that the standoff distance may be adjustable (e.g., via a telescoping mechanism).

The pair of faces 4014 oppose each other. The pair of outer surfaces 4016 oppose each other. The pair of outwardly extending portions 4020 oppose each other. The pair of inwardly extending portions 4022 oppose each other. The apex 4018 opposes the shank 2000 such that the inwardly extending portions 4022 extend between the apex 4018 and the shank 2002. The apex 4018 opposes the shank 2002 such that the stopper 3000 extends between the apex 4018 and the shank 2002 when the stopper 3000 is present. The pair of inwardly extending portions 4022 extend between the shank 2000 (or the stopper 3000 when the stopper 3000 is present) and the pair of outwardly extending portions 4020. The pair of outwardly extending portions 4020 operate similarly to the sloped portions 4008 to widen the open end portion 1508 by flaring. For example, the pair of inwardly extending portions 4022 may terminate at the stopper 3000 (e.g., the outer surface 3004) when the stopper 3000 is present such that the inwardly extending portions 4022 extend between the pair outwardly extending portions 4020 and the stopper 3000 (e.g., the outer surface 3004) when the stopper 3000 is present. As such, the pair of outer surfaces 4016 and the pair of outwardly extending portions 4020 enable the tip 4000 to widen the open end portion 1508 of the tube 1500 by flaring such that the open end portion 1508 is converted to the open end portion 1510. The axis of rotation or the axis of symmetry of the shank 2000 (e.g., the bar 2002) may extend through the plate 4012 between the pair of inwardly extending portions 4022.

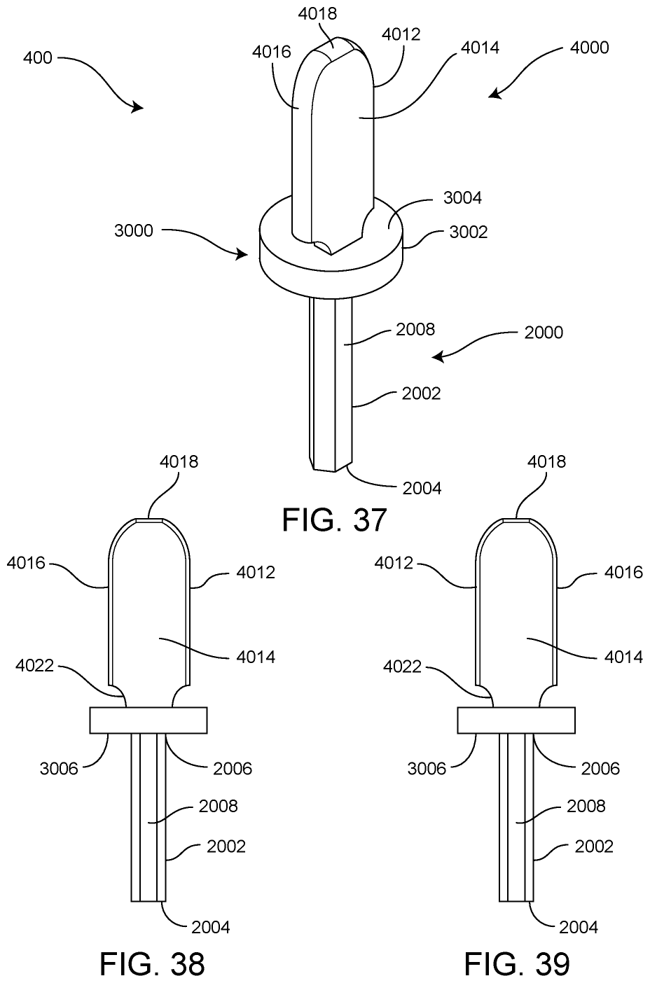

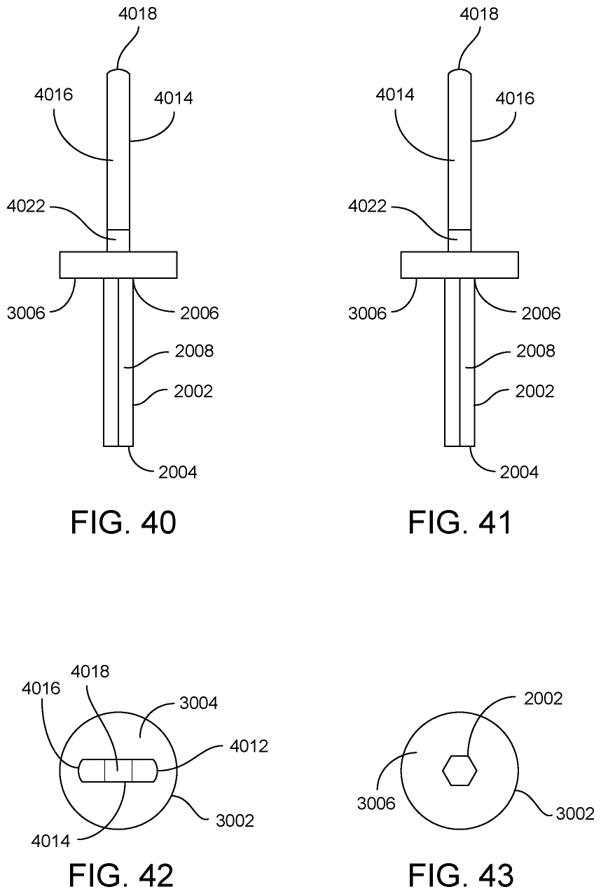

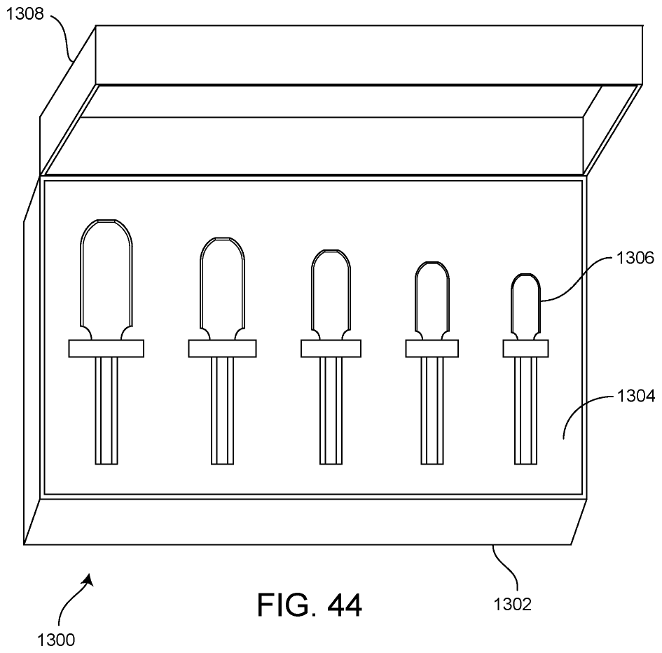

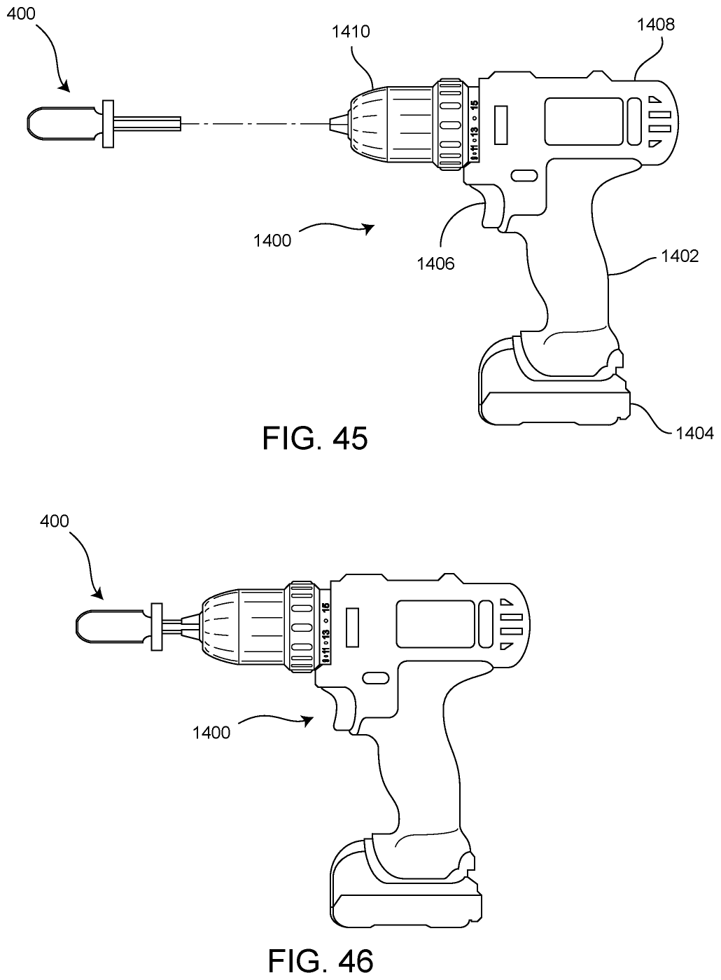

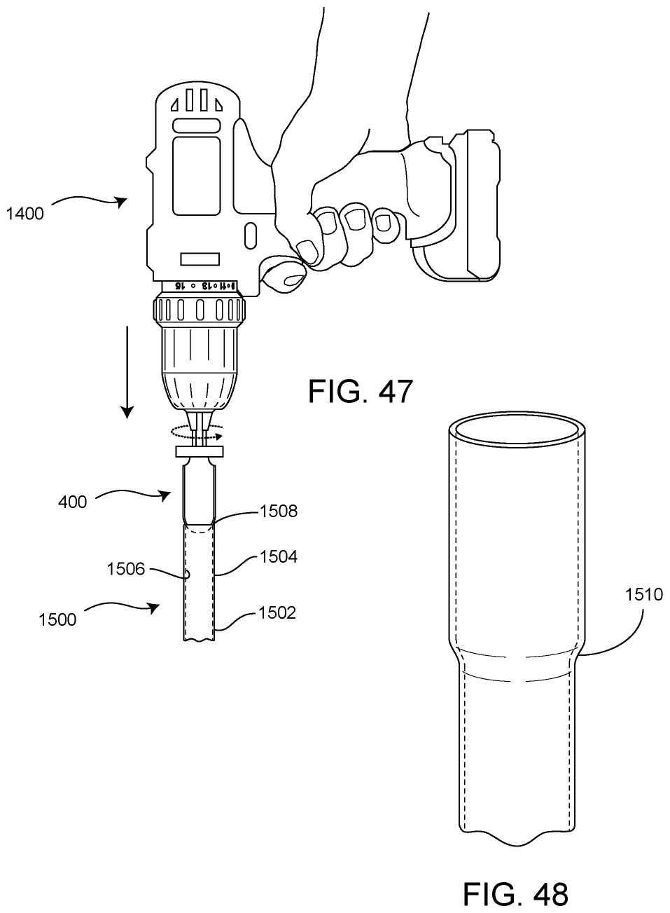

FIG. 37 to FIG. 43 show a bit according to this disclosure. FIG. 44 shows a container storing a set of bits arranged according to a set of sizes according to this disclosure. FIG. 45 to FIG. 46 show how a bit is secured to a chuck of a drill according to this disclosure. FIG. 47 to FIG. 48 show how a bit secured to a chuck of a drill is used to swage an open end of a tube according to this disclosure. In particular, a bit 400 is structurally and functionally similar to the prior bits, manufactured similar to the prior bits, packaged similar to the prior bits, and operated similar to the prior bits. However, unlike the prior bits, the bit 400 does not have the pair of outwardly extending portions 4020. As such, the bit 400 does not widen the open end portion 1508 by flaring. Instead, the bit 400 widens the open end portion 1508 by swaging. This occurs based on the outer surfaces 4016 including the pair of rectilinear portions and avoiding the pair of outwardly extending portions 4020. As such, the pair of inwardly extending portions 4022 start where the pair of rectilinear portions respectively terminate. Therefore, the pair of inwardly extending portions 4022 extends between the shank 2000 and the pair of rectilinear portions. Resultantly, the pair of rectilinear portions enable the tip 4000 (e.g., the plate 4012) to widen the open end portion 1508 of the tube 1500 by swaging such that the open end portion 1508 is converted into the open end portion 1510. The user can control how deep this swaging make take place based on how deep the plate 4012 is inserted into the tube 1500.

When the stopper 3000 present, then the pair of rectilinear portions terminate at the stopper 3000 (e.g., the outer surface 3004) such that the pair of inwardly extending portions 4022 extend between the pair rectilinear portions and the stopper 3000 and the pair of rectilinear portions enable the tip 4000 (e.g., the plate 4012) to widen the open end portion 1508 of the tube 1500 by swaging until the stopper 3000 (e.g., the outer surface 3004) contacts the tube 1500 and the open end portion 1510 is formed.

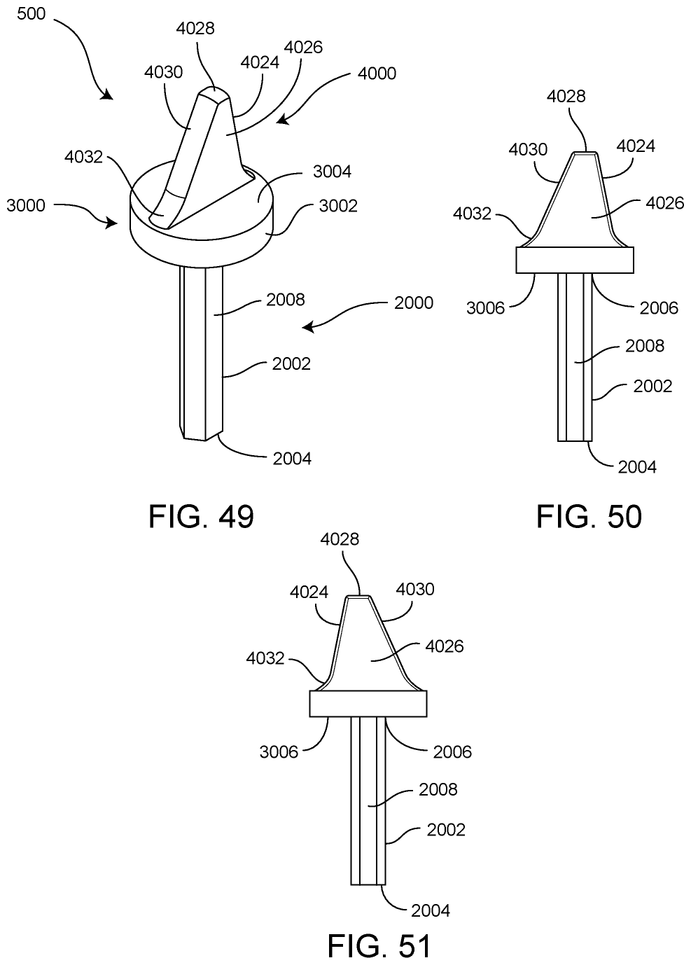

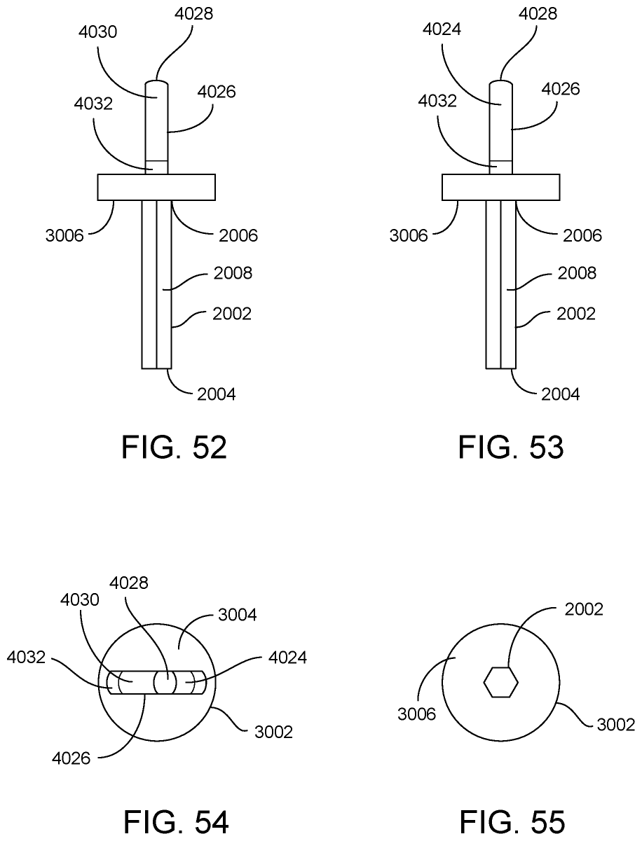

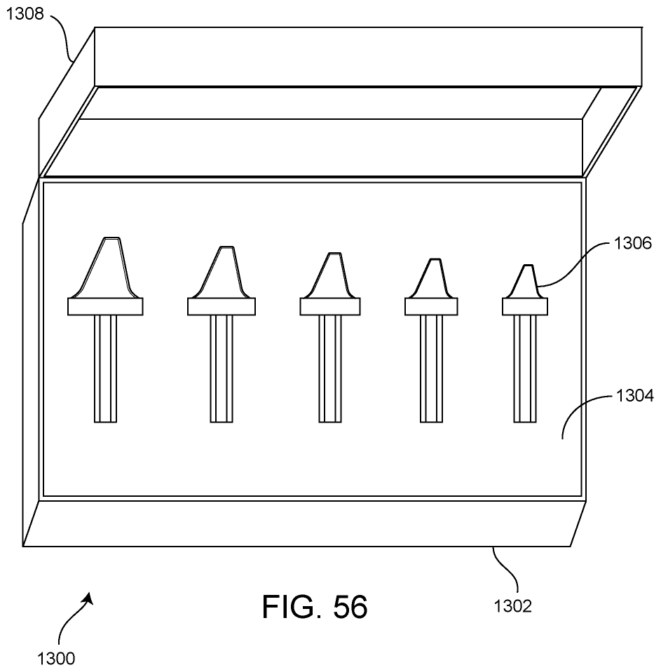

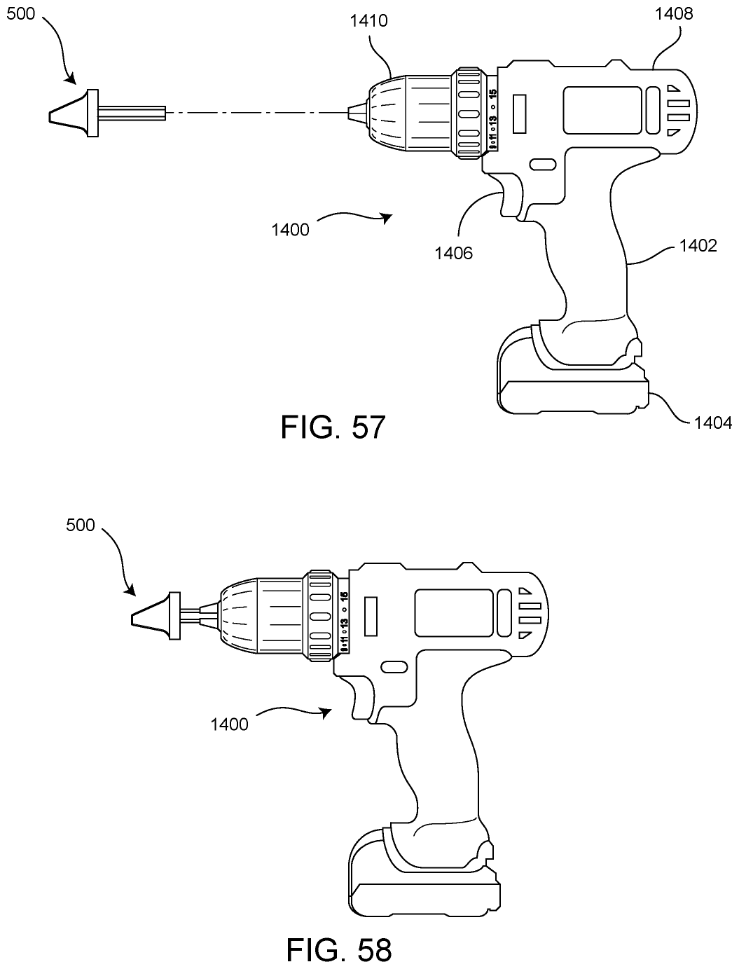

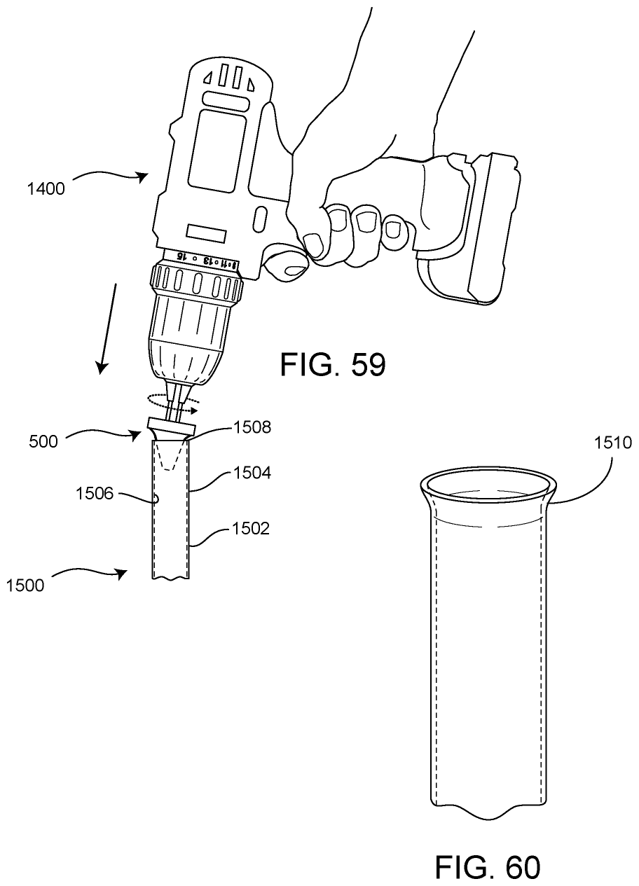

FIG. 49 to FIG. 55 show a bit according to this disclosure. FIG. 56 shows a container storing a set of bits arranged according to a set of sizes according to this disclosure. FIG. 57 to FIG. 58 show how a bit is secured to a chuck of a drill according to this disclosure. FIG. 59 to FIG. 60 show how a bit secured to a chuck of a drill is used to flare an open end of a tube according to this disclosure. In particular, a bit 500 is structurally and functionally similar to the prior bits, manufactured similar to the prior bits, packaged similar to the prior bits, and operated similar to the prior bits. However, the bit 500 differs from the prior bits in that the tip 4000 is structured differently. This occurs via the shank 2000 (e.g., the bar 2002) having the axis of rotation or the axis of symmetry, where this axis of rotation or the axis of symmetry extends through the tip 4000 such that the tip 4000 is asymmetrical (e.g., not co-aligned) to this axis of rotation or the axis of symmetry.

The tip 4000 includes a plate 4024 having a pair of faces 4026, a pair of outer surfaces 4030, an apex 4028, and a pair of outwardly extending portions 4032 terminating the tip 4000 and enabling the tip 4000 to widen the open end portion of the tube by flaring the open end portion 1508 to appear as the open end portion 1510. The stopper 3000 may extend past the pair of outwardly extending portions 4032 to contact the open end portion 1510 when flaring, which may enable stopping such flaring.

The pair of faces 4026 oppose each other. The pair of outer surfaces 4030 oppose each other. The pair of outwardly extending portions 4032 oppose each other. The apex 4028 opposes the shank 2000 such that the pair of outwardly extending portions 4032 extend between the apex 4028 and the shank 2002. The apex 4018 opposes the shank 2002 such that the stopper 3000 extends between the apex 4018 and the shank 2002 when the stopper 3000 is present. The pair of outwardly extending portions 4032 operate similarly to the sloped portions 4008 to widen the open end portion 1508 by flaring. For example, the pair of outer surfaces 4030 and the pair of outwardly extending portions 4032 enable the tip 4000 to widen the open end portion 1508 of the tube 1500 by flaring such that the open end portion 1508 is converted to the open end portion 1510. The axis of rotation or the axis of symmetry of the shank 2000 (e.g., the bar 2002) may extend through the plate 4012 between the pair of outwardly extending portions 4032.

When the stopper 3000 is present, then the shank 2000 extends from the stopper 3000 (e.g., the outer surface 3006) and the pair of outwardly extending portions 4032 terminate at the stopper 3000 (e.g., the outer surface 3004) such that the stopper 3000 extends between the pair of outwardly extending portions 4032 and the shank 2000. The pair of outwardly extending portions 4032 enable the tip 4000 to widen (e.g., flare) the open end portion 1508 of the tube 1510 by flaring the open end portion 1508 to appear as the open end portion 1510 until the stopper 3000 (e.g., the outer surface 3004) contacts the tube 1500 (e.g., the open end portion 1510).

The tip 4000 being asymmetrical (e.g., not co-aligned) to the axis of rotation or the axis of symmetry of the shank 2000 may provide various technological advantages. For example, this configuration allows the user to widen (e.g., flare) the open end portion 1508 of the tube 1500 at an off-angle when the axis of rotation or the axis of symmetry of the shank 2000 is not co-aligned (e.g., intersecting) with a longitudinal axis of the tube 1500, as shown in FIG. 59. The off-angle operation may be useful when working tight spaces.

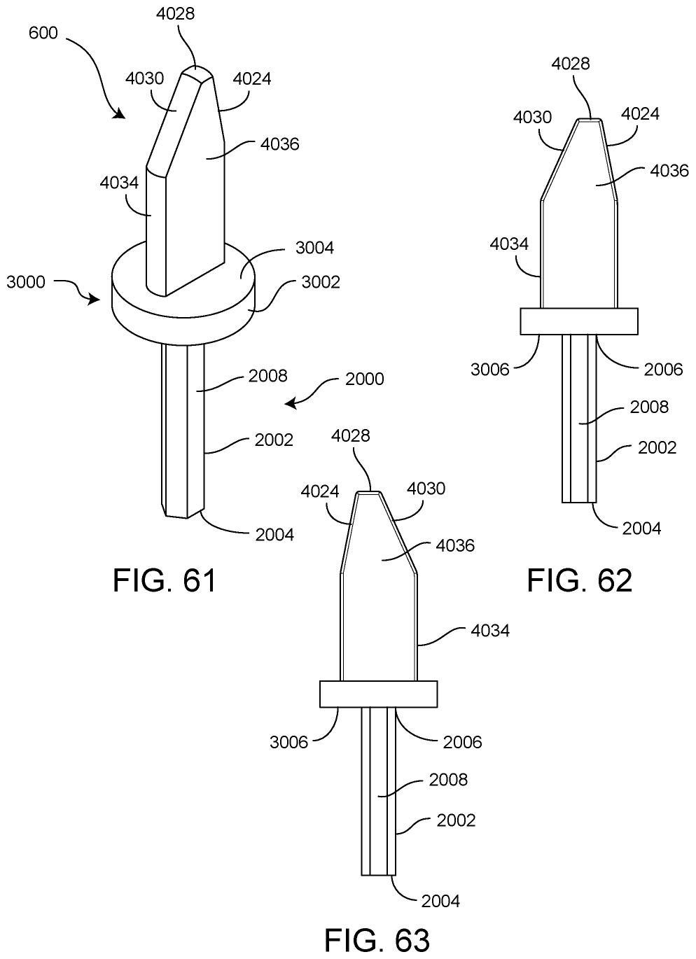

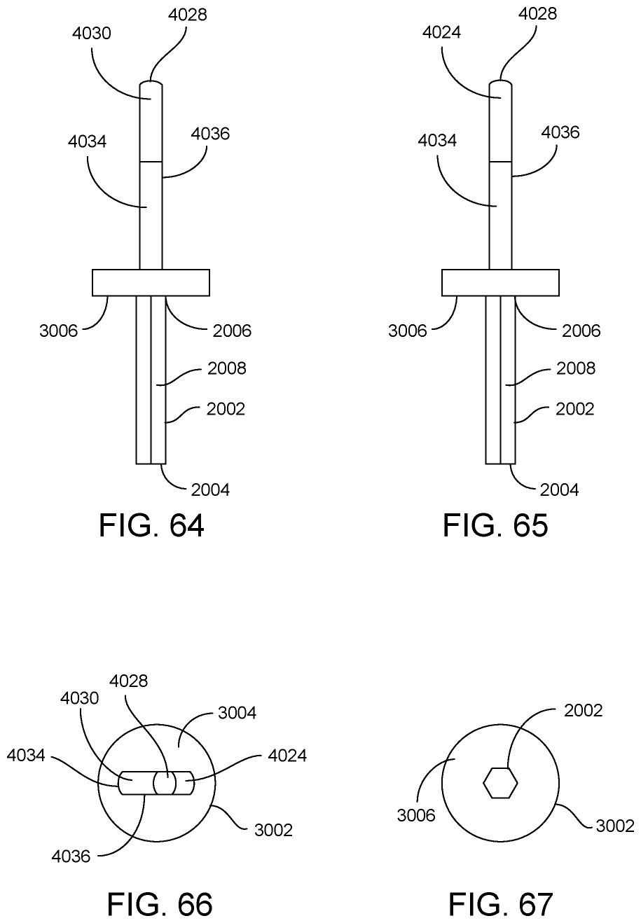

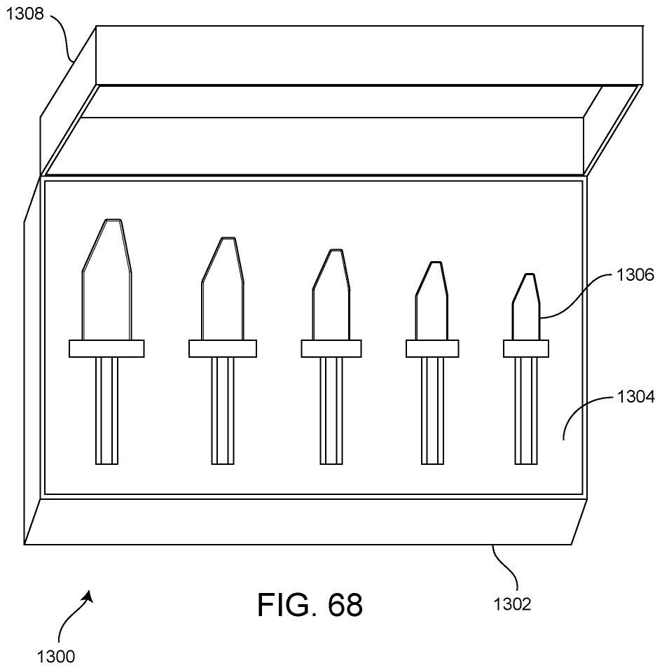

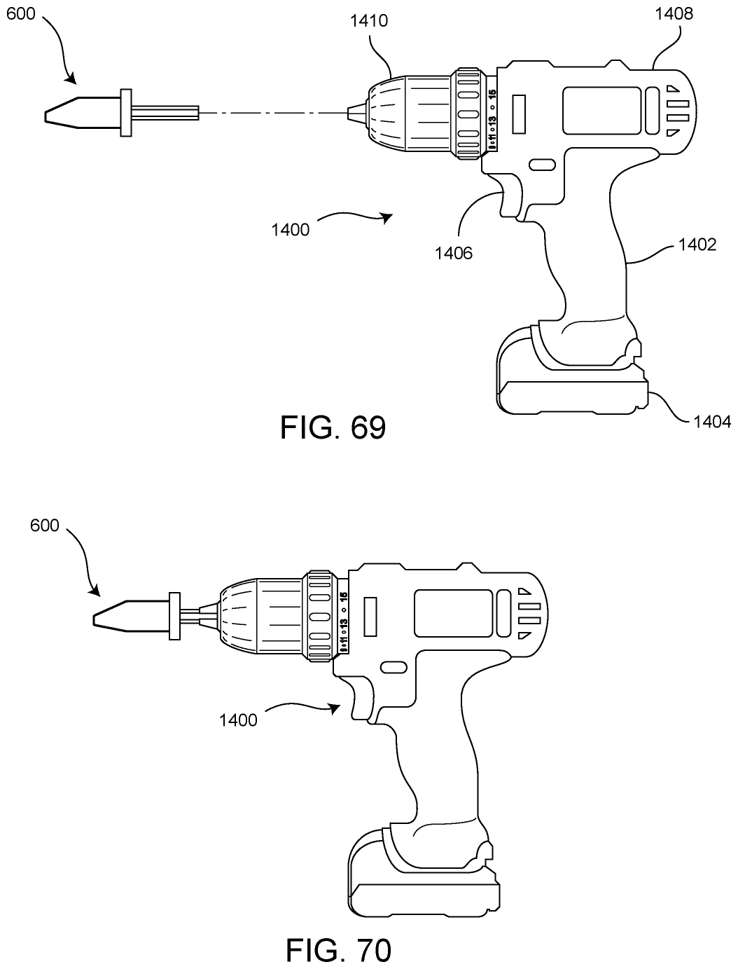

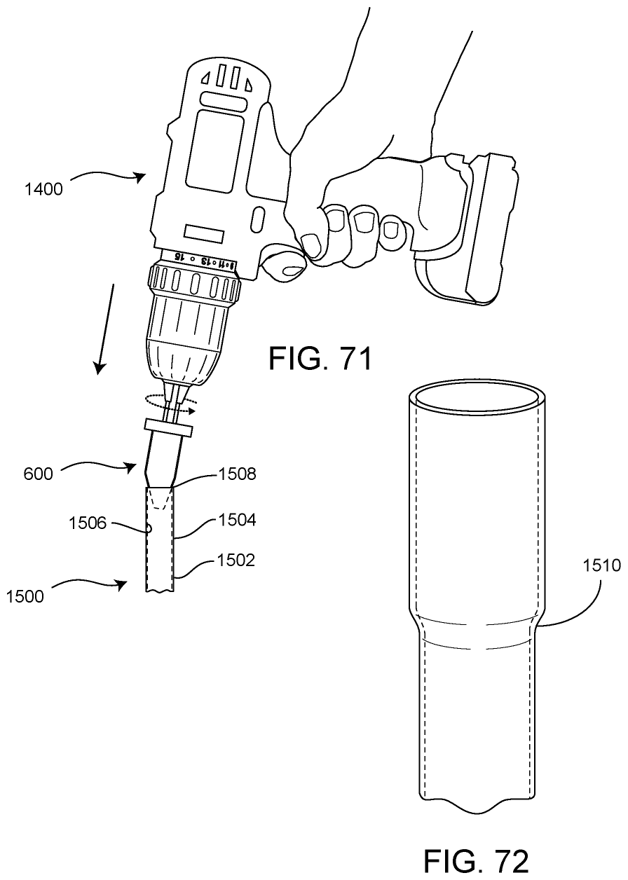

FIG. 61 to FIG. 67 show a bit according to this disclosure. FIG. 68 shows a container storing a set of bits arranged according to a set of sizes according to this disclosure. FIG. 69 to FIG. 70 show how a bit is secured to a chuck of a drill according to this disclosure. FIG. 71 to FIG. 72 show how a bit secured to a chuck of a drill is used to swage an open end of a tube according to this disclosure. In particular, a bit 600 is structurally and functionally similar to the prior bits, manufactured similar to the prior bits, packaged similar to the prior bits, and operated similar to the prior bits. However, unlike the prior bits, the bit 600 does not have the pair of outwardly extending portions 4032. As such, the bit 600 does not widen the open end portion 1508 by flaring. Instead, the bit 600 widens the open end portion 1508 by swaging. This occurs based on the outer surfaces 4030 including a pair of rectilinear portions 4034 terminating the tip 4000 (e.g., the plate 4024) and avoiding the pair of outwardly extending portions 4032. Further, the tip 4000 includes a pair of flat sides 4036 extending below the pair of faces 4026 spanning between the pair of outer surfaces 4030 and the pair of rectilinear portions 4034. As such, the pair of rectilinear portions 4034 enable the tip 4000 to widen (e.g., swage) the open end portion 1508 of the tube 1500 by swaging to convert the open end portion 1508 to appear as the open end portion 1510.

When the bit 600 includes the stopper 3000, then the shank 2000 (e.g., the end portion 2006) extends from the stopper 3000 (e.g., the outer surface 3006) and the pair of rectilinear portions 4034 terminate at the stopper 3000 (e.g., the outer surface 3004) such that the stopper 3000 extends between the pair of rectilinear portions 4034 and the shank 2000. Therefore, the pair of rectilinear portions 4034 enable the tip 4000 to widen (e.g., swage) the open end portion 1508 of the tube 1500 by swaging the open end portion 1508 until the stopper 3000 (e.g., the outer surface 3004) contacts the tube 1500 and the open end portion 1508 appears as the open end portion 1510.

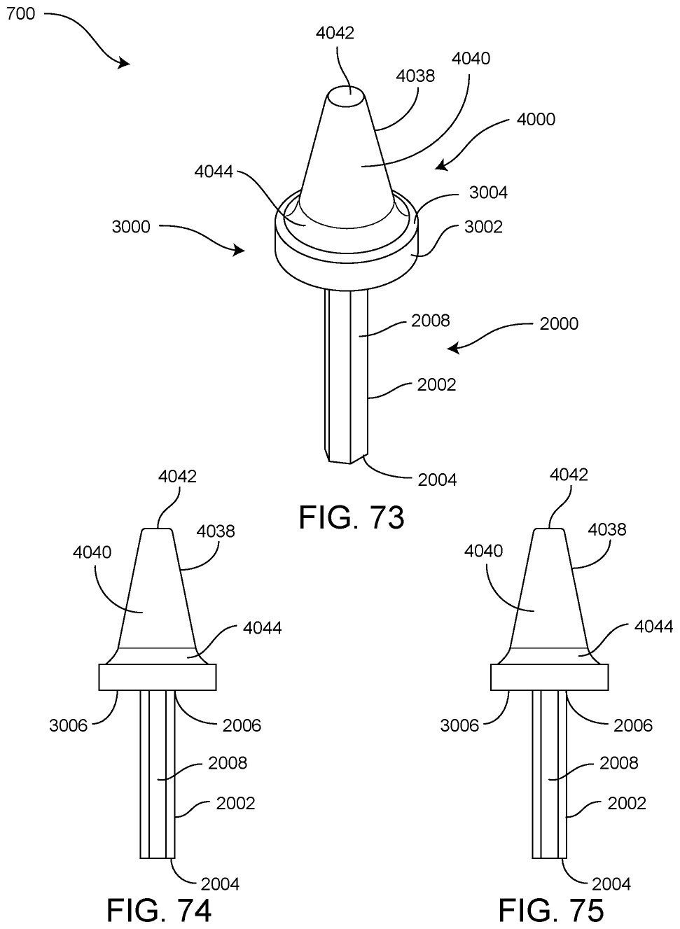

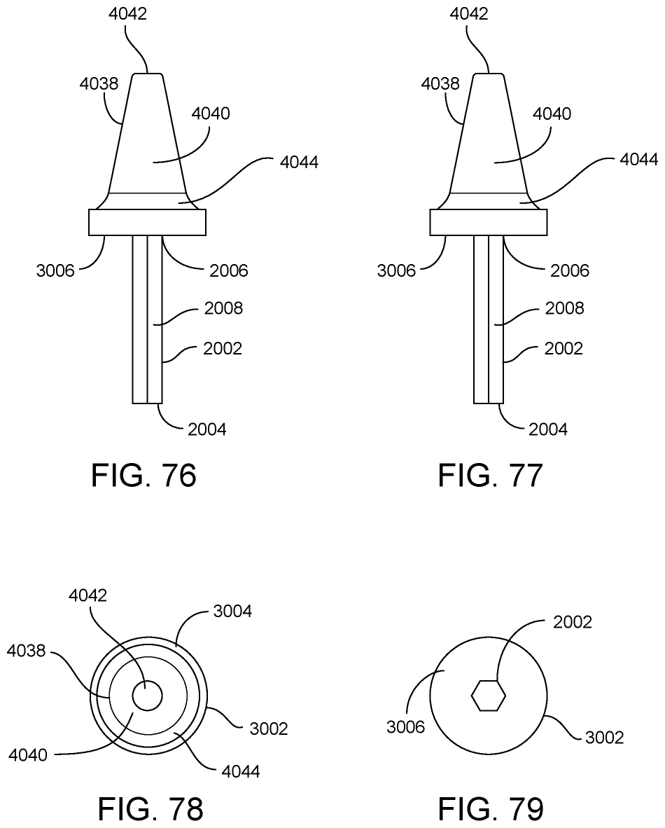

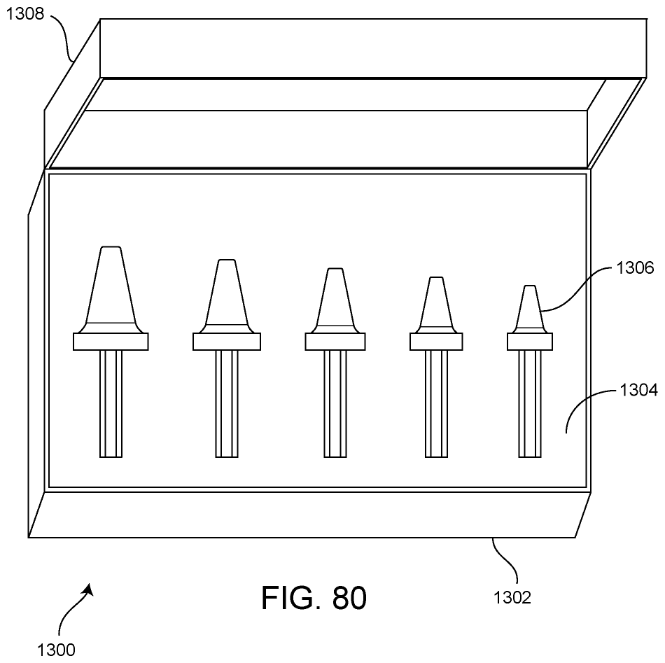

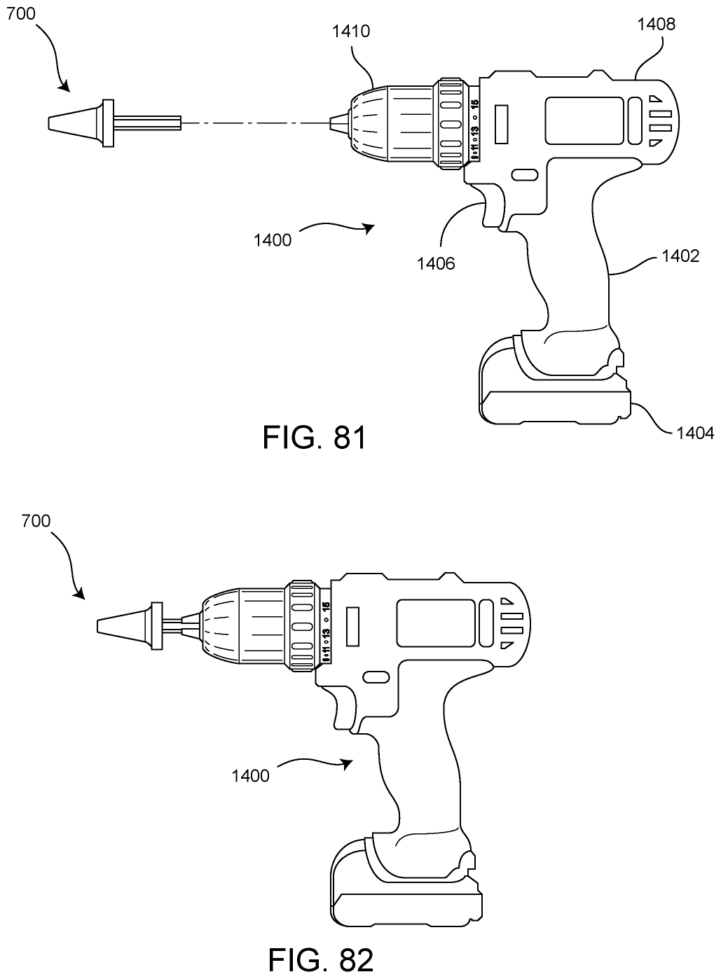

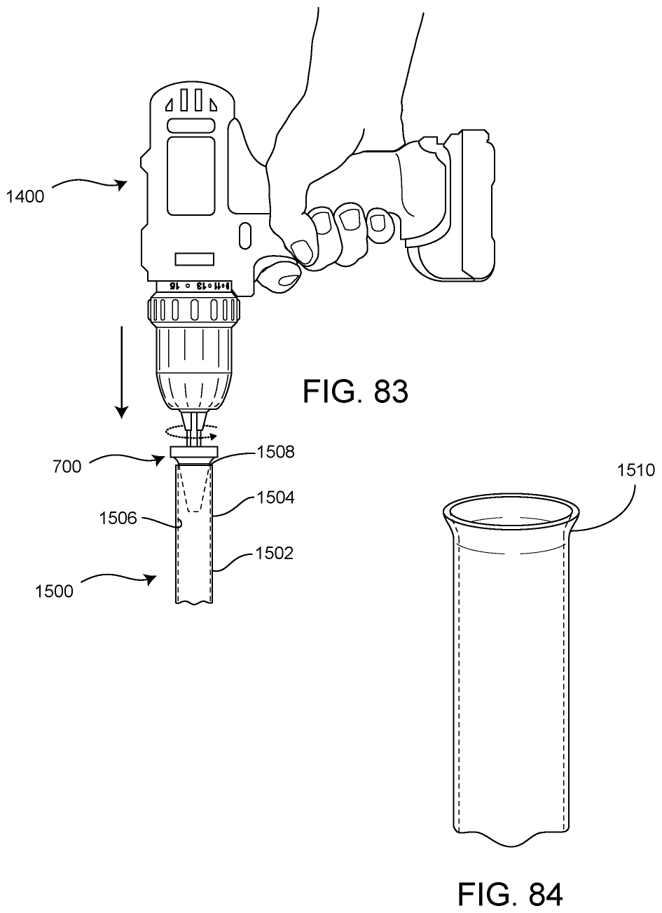

FIG. 73 to FIG. 79 show a bit according to this disclosure. FIG. 80 shows a container storing a set of bits arranged according to a set of sizes according to this disclosure. FIG. 81 to FIG. 82 show how a bit is secured to a chuck of a drill according to this disclosure. FIG. 83 to FIG. 84 show how a bit secured to a chuck of a drill is used to flare an open end of a tube according to this disclosure. In particular, a bit 700 is structurally and functionally similar to the prior bits, manufactured similar to the prior bits, packaged similar to the prior bits, and operated similar to the prior bits. However, the bit 700 differs from the prior bits in that the tip 4000 is structured differently. This occurs when the tip 4000 includes a cone 4038 having a sidewall 4040 that is conical in extension or defines the cone 4038 and narrows in width away from the shank 2000. This configuration may be technologically advantageous for various reasons. For example, the sidewall 400 may have of a large surface area engaging with the open end portion 1508, as disclosed herein, which enables widening (e.g., flaring) of the open end portion 1508 to occur faster due to quicker heat generation making the tube 1500 more malleable. For example, the cone 4038 may be insertable into the open end portion 1508 of various sizes due to its tapering structure.

The tip 4000 further includes an apex 4042 that is flat for safety purposes, but can be sharp, acute, or pointy if puncturing of material (e.g., a paper seal) is needed. The tip 4000 includes an outwardly extending portion 4044 (e.g., cone-shaped) terminating the tip 4000. The stopper 3000 may extend past the outwardly extending portion 4044 to contact the open end portion 1510 when flaring, which may enable stopping such flaring. As such, the sidewall 4040 and the outwardly extending portion enable the tip 4000 to widen (e.g., flare) the open end portion 1508 of the tube 1500 by flaring the open end portion 1508 to appear as the open end portion 1510.

When the bit 700 includes the stopper 300, then the shank 2000 extends from the stopper 3000 (e.g., outer surface 3006) and the outwardly extending portion 4044 terminates at the stopper 3000 (e.g., the outer surface 3004) such that the stopper 3000 extends between the outwardly extending portion 4044 and the shank 2000. As such, the outwardly extending portion 4044 enables the tip 4000 to widen (e.g., flare) the open end portion 1504 of the tube 1500 by flaring until the stopper 3000 (e.g., the outer surface 3004) contacts the tube 1500 (e.g., the open end portion 1510) and the open end portion 1508 appears as the open end portion 1510.

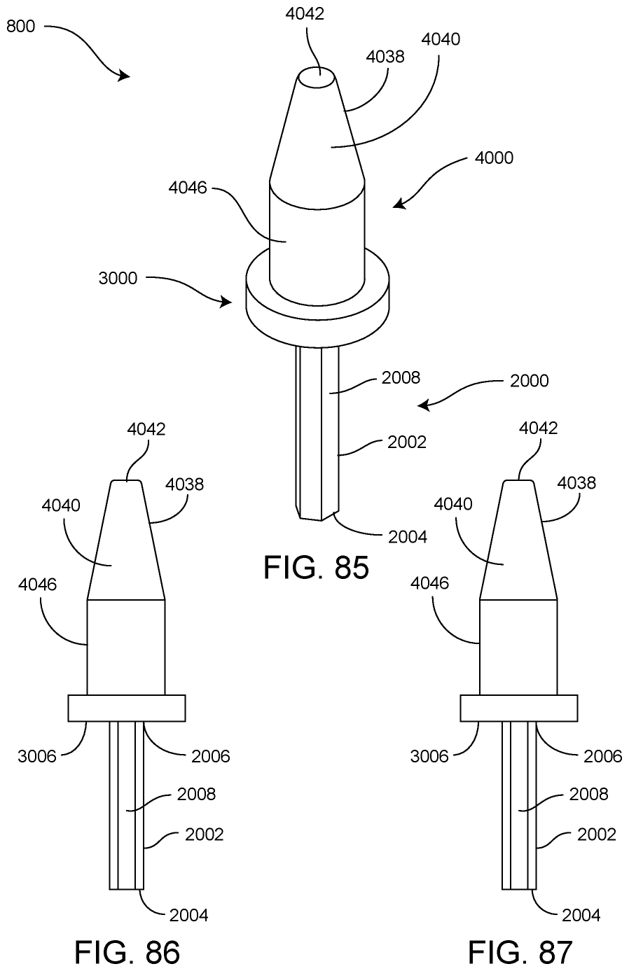

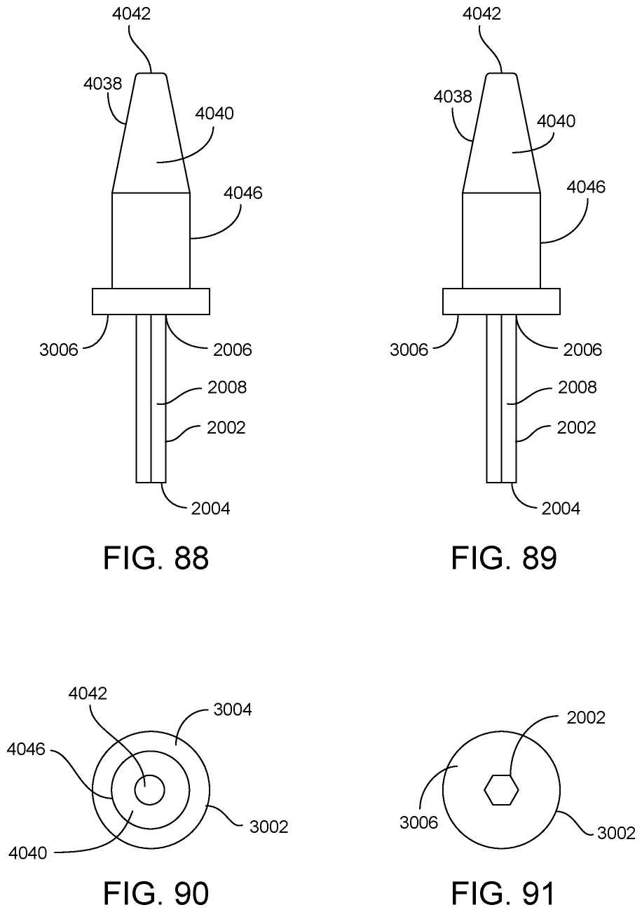

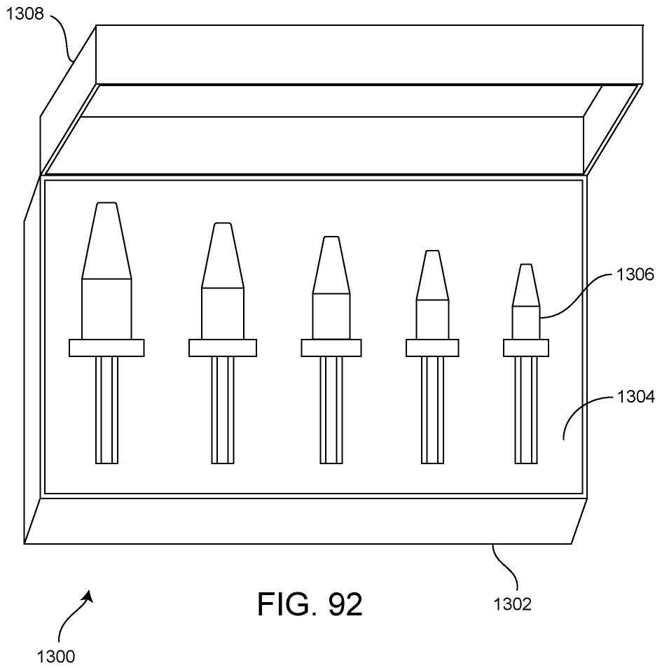

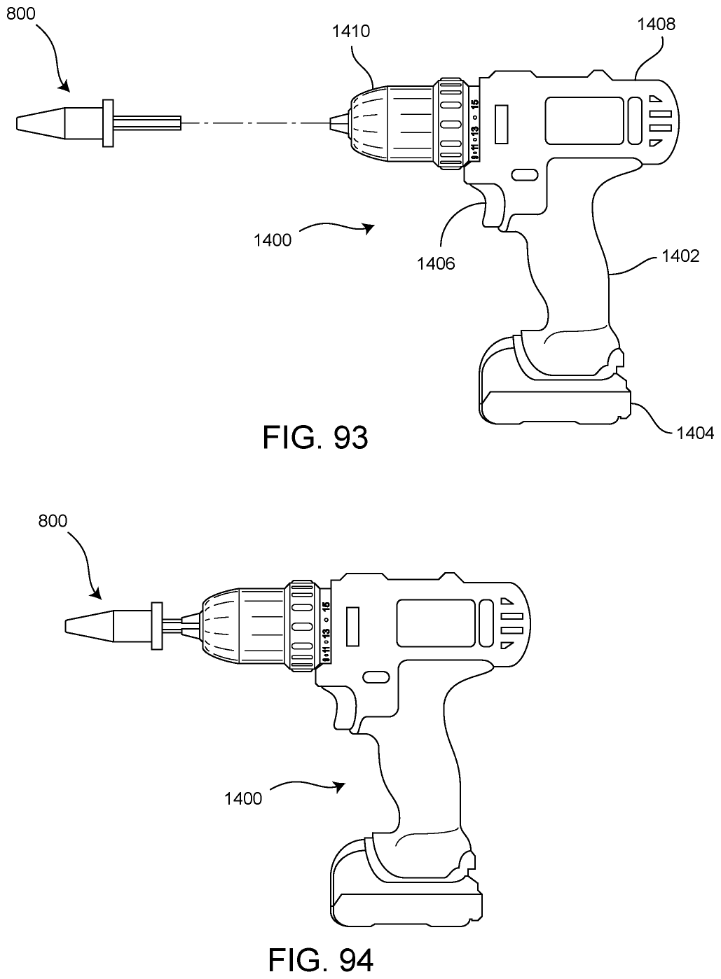

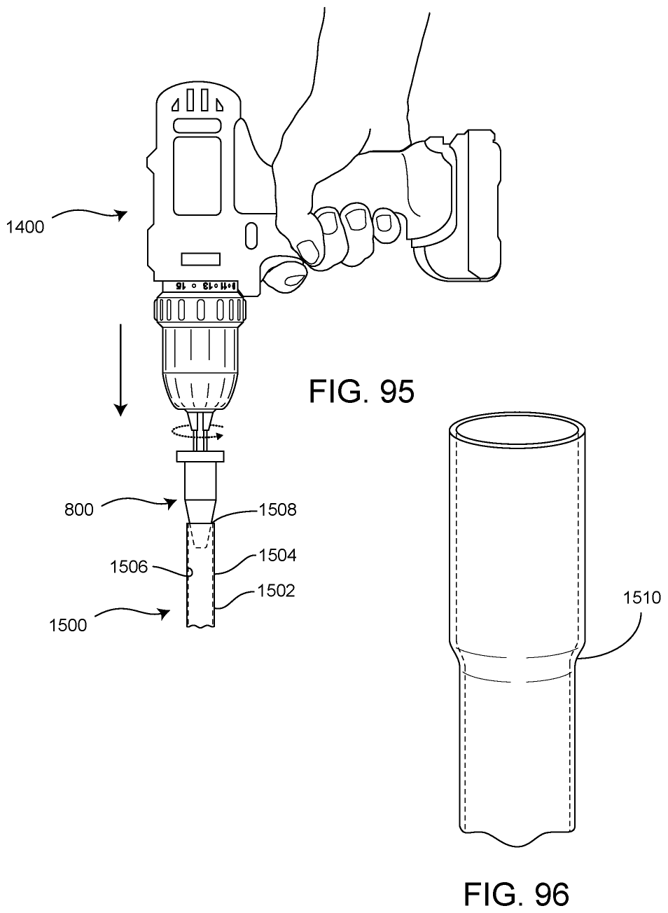

FIG. 85 to FIG. 91 show a bit according to this disclosure. FIG. 92 shows a container storing a set of bits arranged according to a set of sizes according to this disclosure. FIG. 93 to FIG. 94 show how a bit is secured to a chuck of a drill according to this disclosure. FIG. 95 to FIG. 96 show how a bit secured to a chuck of a drill is used to swage an open end of a tube according to this disclosure. In particular, a bit 800 is structurally and functionally similar to the prior bits, manufactured similar to the prior bits, packaged similar to the prior bits, and operated similar to the prior bits. However, unlike the prior bits, the bit 800 does not have the outwardly extending portion 4044. As such, the bit 800 does not widen the open end portion 1508 by flaring. Instead, the bit 800 widens the open end portion 1508 by swaging. This occurs based on the tip 4000 including a rectilinear portion (e.g., a right cylinder) 4046 terminating the tip 4000 and avoiding the outwardly extending portion 4044. The tip 4000 has the cone 4038 (e.g., the sidewall 4040) and the rectilinear portion 4046 being immediately adjacent to each other. As such, the rectilinear portion 4046 enables the tip 4000 to widen (e.g., swage) the open end portion 1504 of the tube 1500 by swaging to convert the open end portion 1508 to appear as the open end portion 1510.

When the tip 4000 includes the stopper 3000, then the shank 2000 extends from the stopper 3000 (e.g., the outer surface 3006). The rectilinear portion 4046 terminates at the stopper 3000 (e.g., the outer surface 3004) such that the stopper 3000 extends between the rectilinear portion 4046 and the shank 3000. As such, the rectilinear portion 4046 enables the tip 4000 to widen (e.g., swage) the open end portion 1508 of the tube 1500 by swaging until the stopper 3000 (e.g., the outer surface 3004) contacts the tube 1500 (e.g., the open end portion 1510) and the open end portion 1508 appears as the open end portion 1510.

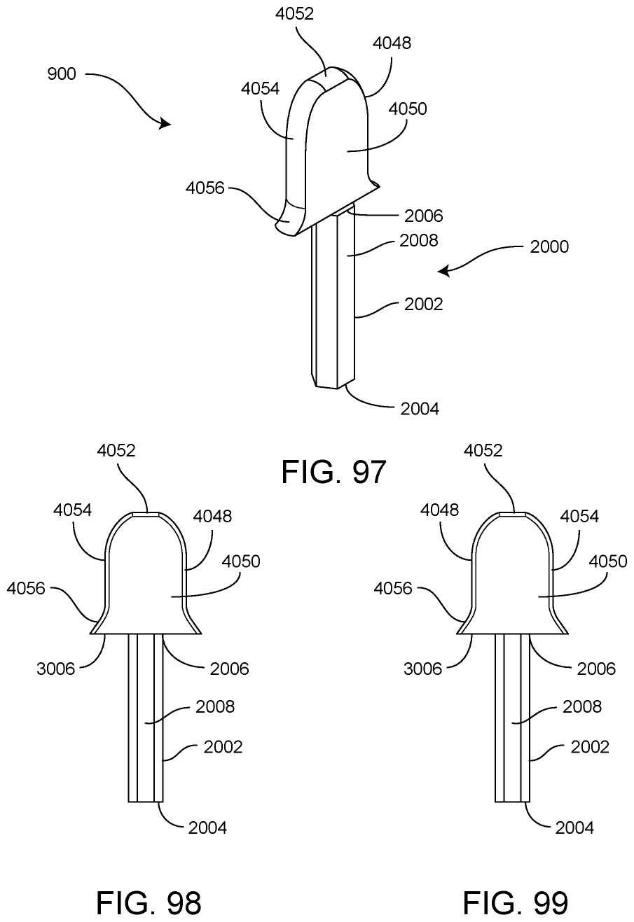

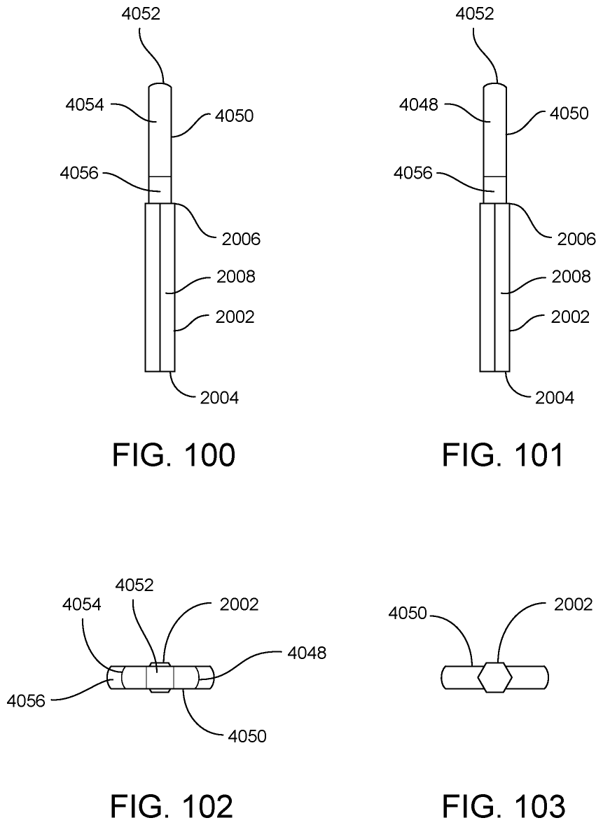

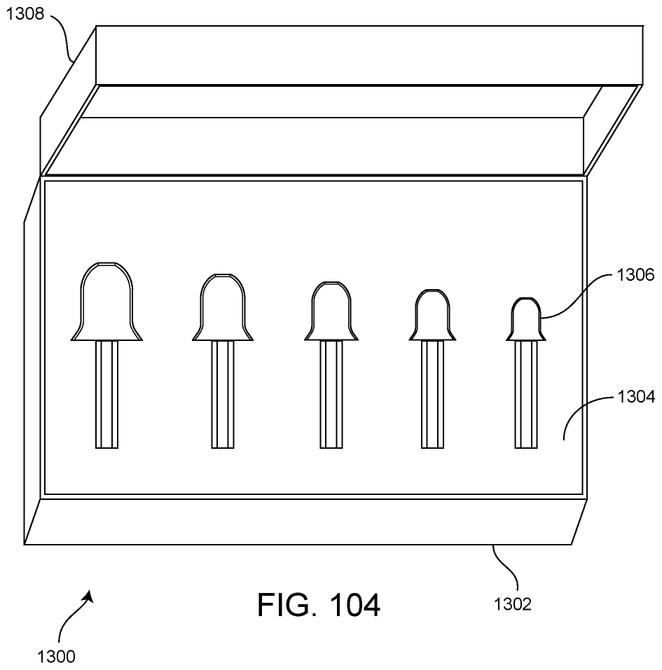

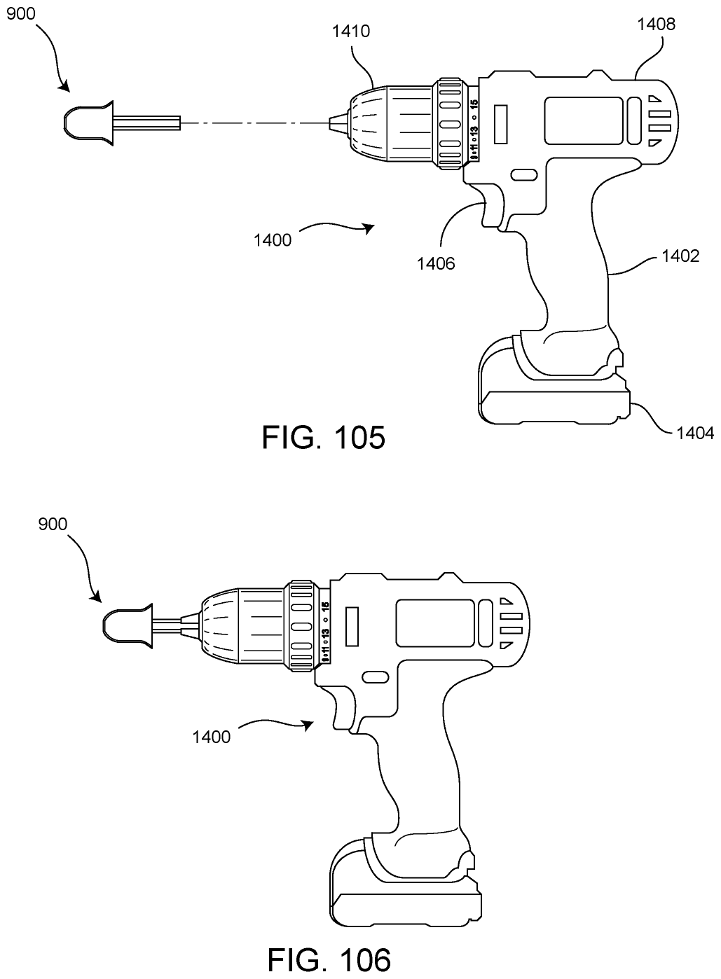

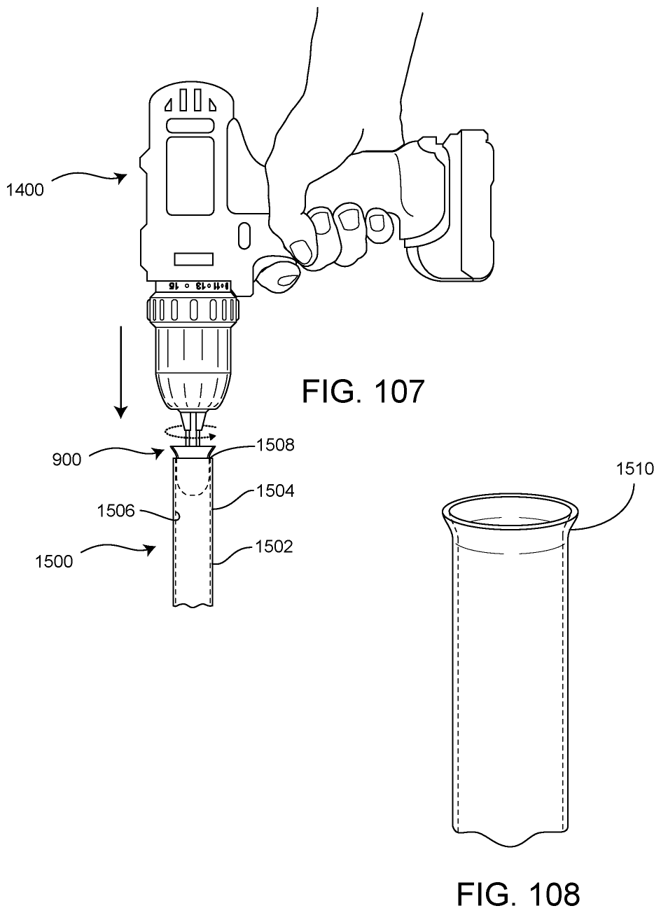

FIG. 97 to FIG. 103 show a bit according to this disclosure. FIG. 104 shows a container storing a set of bits arranged according to a set of sizes according to this disclosure. FIG. 105 to FIG. 106 show how a bit is secured to a chuck of a drill according to this disclosure. FIG. 107 to FIG. 108 show how a bit secured to a chuck of a drill is used to flare an open end of a tube according to this disclosure. In particular, a bit 900 is structurally and functionally similar to the prior bits, manufactured similar to the prior bits, packaged similar to the prior bits, and operated similar to the prior bits. However, the bit 900 differs from the prior bits in that the tip 4000 is structured differently. This occurs when the bit 900 avoids the stopper 3000, as disclosed herein. For example, the shank 2000 may directly extend from the tip 4000 without having the stopper 3000 extend between the shank 2000 and the tip 4000. This configuration may provide various technological advantages. For example, the bit 900 may avoid using excessive material, which may reduce manufacturing cost and increase manufacturing speed.

The bit 900 includes a plate 4048 having a pair of faces 4050, a pair of outer surfaces 4054, an apex 4052, and a pair of outwardly extending portions 4056 terminating the tip 4000 and enabling the tip 4000 to widen the open end portion of the tube by flaring the open end portion 1508 to appear as the open end portion 1510. The pair of faces 4050 oppose each other. The pair of outer surfaces 4054 oppose each other. The pair of outwardly extending portions 4056 oppose each other. The apex 4052 opposes the shank 2000 such that the pair of outwardly extending portions 4056 extend between the apex 4052 and the shank 2002. The pair of outwardly extending portions 4056 operate similarly to the sloped portions 4008 to widen the open end portion 1508 by flaring. For example, the pair of outer surfaces 4054 and the pair of outwardly extending portions 4056 enable the tip 4000 to widen the open end portion 1508 of the tube 1500 by flaring such that the open end portion 1508 is converted to the open end portion 1510. The axis of rotation or the axis of symmetry of the shank 2000 (e.g., the bar 2002) may extend through the plate 4048 between the pair of outwardly extending portions 4056.

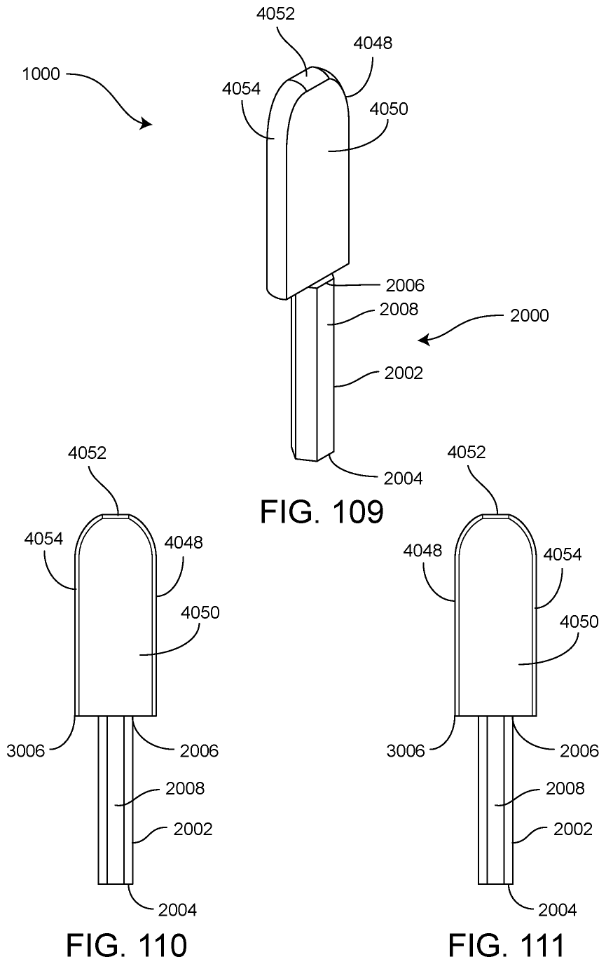

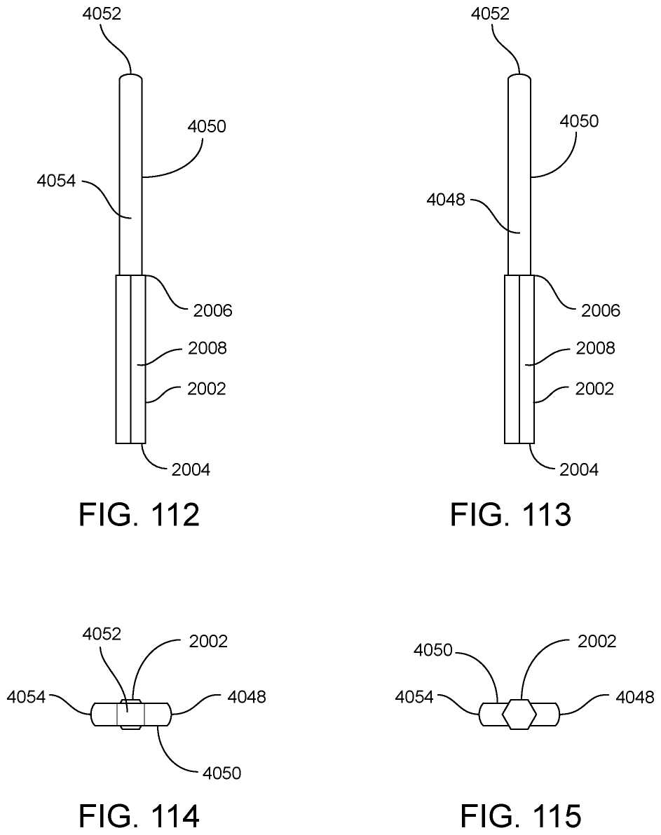

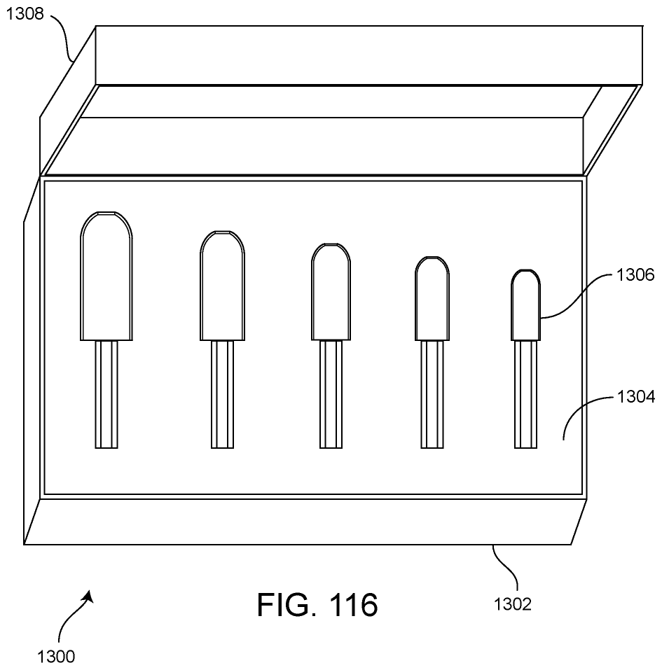

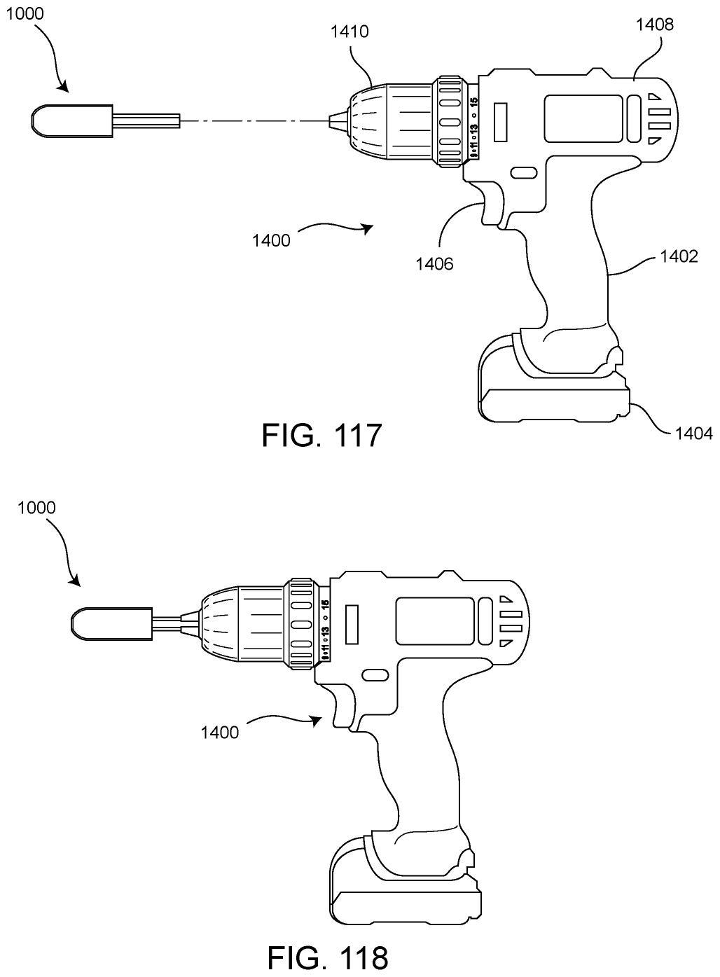

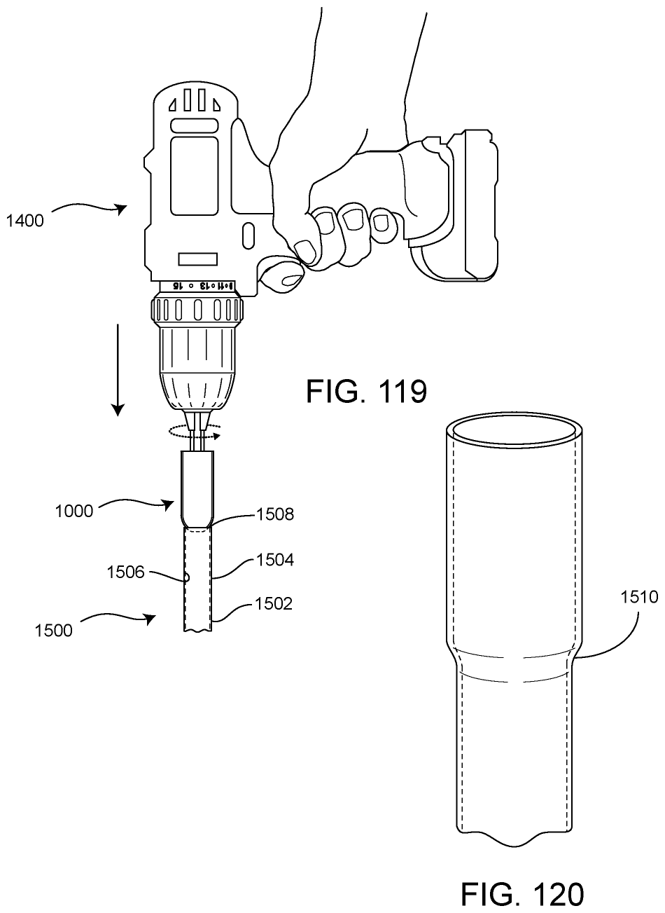

FIG. 109 to FIG. 115 show a bit according to this disclosure. FIG. 116 shows a container storing a set of bits arranged according to a set of sizes according to this disclosure. FIG. 117 to FIG. 118 show how a bit is secured to a chuck of a drill according to this disclosure. FIG. 119 to FIG. 120 show how a bit secured to a chuck of a drill is used to swage an open end of a tube according to this disclosure. In particular, a bit 1000 is structurally and functionally similar to the prior bits, manufactured similar to the prior bits, packaged similar to the prior bits, and operated similar to the prior bits. However, unlike the prior bits, the bit 1000 does not have the outwardly extending portion 4056. As such, the bit 1000 does not widen the open end portion 1508 by flaring. Instead, the bit 1000 widens the open end portion 1508 by swaging. This occurs based on the tip 4000 having the outer surfaces 4054 include a pair of rectilinear portions terminating the tip 4000 such that the pair of rectilinear portions enable the tip 4000 to widen (e.g., swage) the open end portion 1508 of the tube 1500 by swaging to convert the open end portion 1508 to appear as the open end portion 1510. This configuration may provide various technological advantages. For example, the bit 1000 may avoid using excessive material, which may reduce manufacturing cost and increase manufacturing speed. For example, the bit 1000 provides the user with more control on how deep the user desires to insert the bit 1000 into the tube 1500.

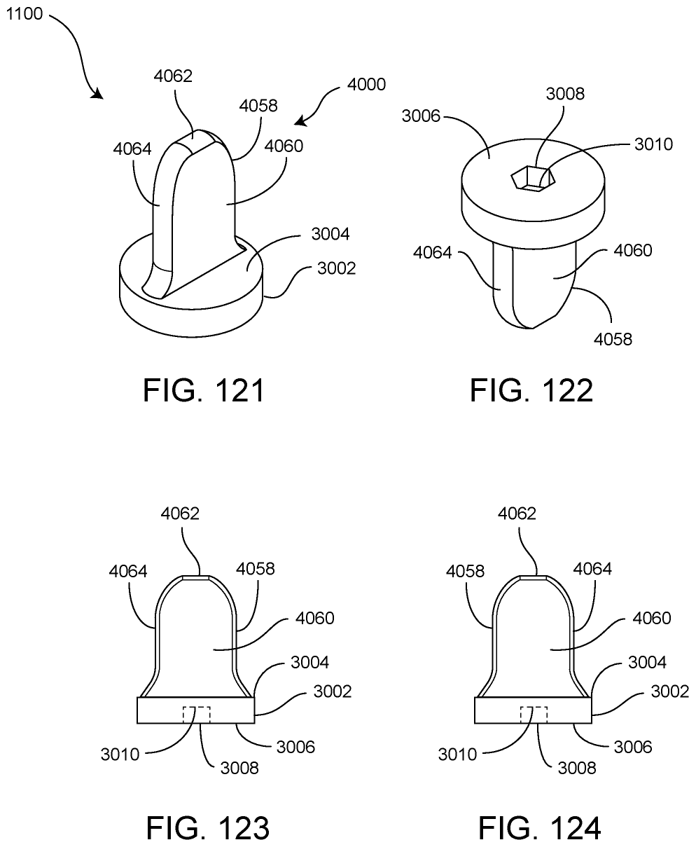

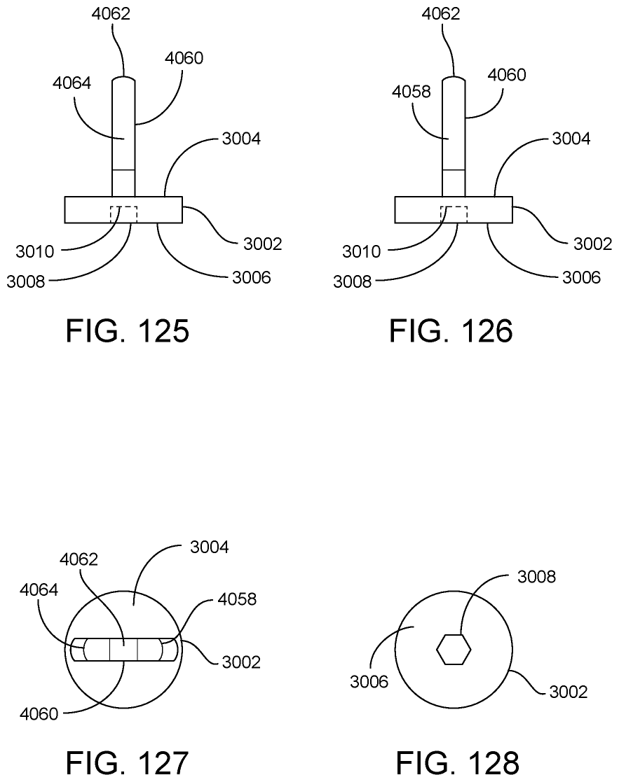

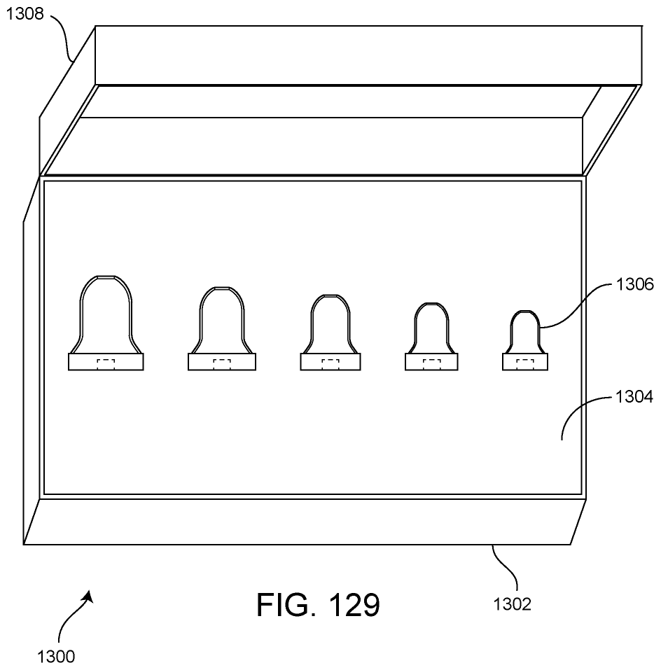

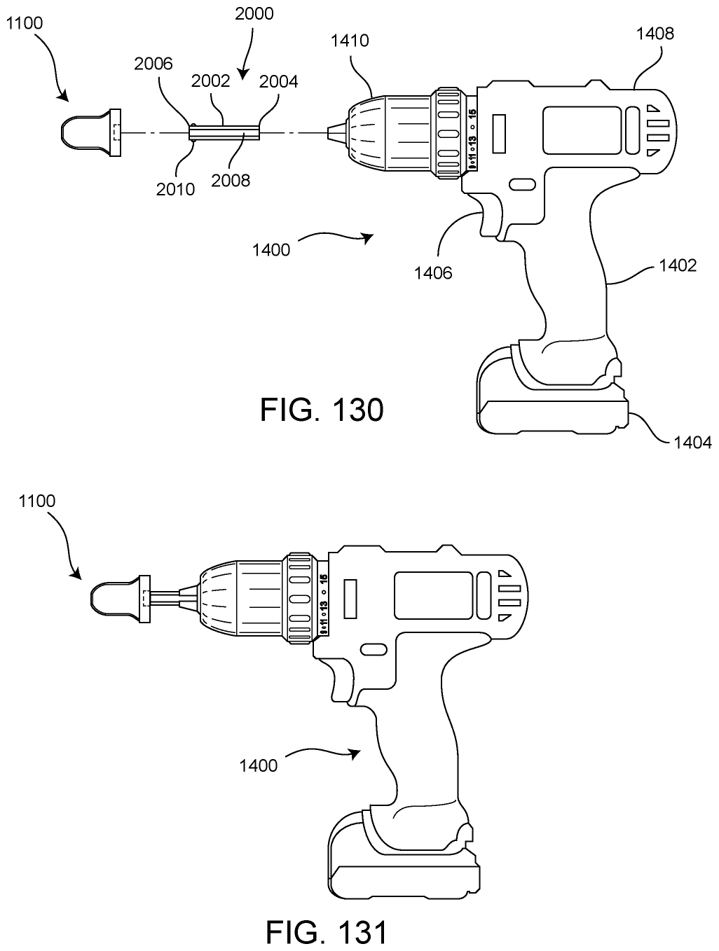

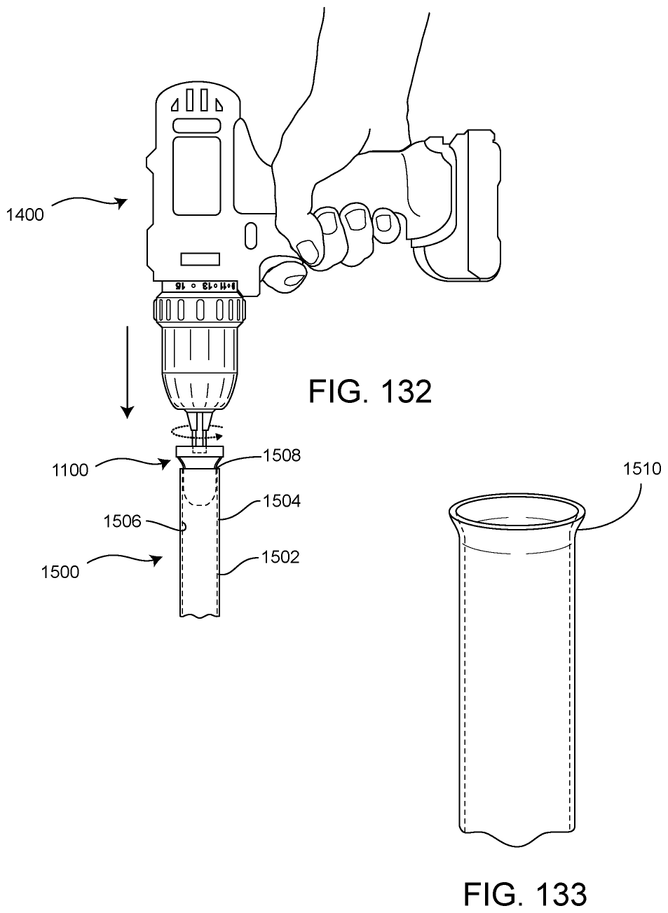

FIG. 121 to FIG. 128 show a bit according to this disclosure. FIG. 129 shows a container storing a set of bits arranged according to a set of sizes according to this disclosure. FIG. 130 to FIG. 131 show how a bit is secured to a chuck of a drill according to this disclosure. FIG. 132 to FIG. 133 show how a bit secured to a chuck of a drill is used to flare an open end of a tube according to this disclosure. In particular, a bit 1100 is structurally and functionally similar to the prior bits, manufactured similar to the prior bits, packaged similar to the prior bits, and operated similar to the prior bits. However, the bit 1100 differs from the prior bits in that the shank 2000 and the tip 4000 that are attachable to each other. This form of attachment can include mating (e.g., a male component mating with a female component), a ball-detent mechanism, adhering, fastening, or other securing techniques. This configuration may provide various technological advantages. For example, the bit 1100 may be easier to package in the container 1302 (e.g., denser positioning, stacking) or distributed over multiple containers 1302. For example, the tip 4000 may be interchangeable with other tips, as disclosed herein, while using a common shank 2000. Note that the shank 2000 and the tip 4000 may be attachable to each other as a one-time event. For example, the shank 2000 and the tip 4000 may be permanently attached to each other by the user as one-time event. However, note that the shank 2000 and the tip 4000 may also be detachably attachable to each other such that the shank 2000 and the tip 4000 may be detached from each other after being attached, but this is not required.

The tip 1100 includes a plate 4058 having a pair of faces 4060, a pair of outer surfaces 4064, an apex 4062, and a pair of outwardly extending portions terminating the tip 4000 and enabling the tip 4000 to widen the open end portion of the tube by flaring the open end portion 1508 to appear as the open end portion 1510. The pair of faces 4060 oppose each other. The pair of outer surfaces 4064 oppose each other. The pair of outwardly extending portions oppose each other. The apex 4062 opposes the shank 2000 such that the pair of outwardly extending portions extend between the apex 4062 and the shank 2002. The pair of outwardly extending portions operate similarly to the sloped portions 4008 to widen the open end portion 1508 by flaring. For example, the pair of outer surfaces 4064 and the pair of outwardly extending portions enable the tip 4000 to widen the open end portion 1508 of the tube 1500 by flaring such that the open end portion 1508 is converted to the open end portion 1510.

The tip 4000 or the stopper 3000 includes a bore 3008 (e.g., a well) having a cavity 3010 configured to receive the end portion 2006 of the shank 2000. For example, the tip 4000 may include the bore 3008 or the stopper 3000 may include the bore 3008, whether the tip 4000 is monolithic with the stopper 3000 or whether the tip 4000 is assembled with the stopper 3000 (e.g., mating, fastening, a ball-and-detent mechanism). Regardless, the bore 3008 is shaped to receive the end portion 2006, as appropriate. The cavity 3010 forms a depression and the end portion 2006 includes a projection (e.g., a ball) 2010. Collectively, the depression and the projection form a ball-detent mechanism by which the shank 2000 and the tip 4000 attach to each other, as shown in FIG. 130, although this configuration can be reversed (e.g., the cavity 3010 includes the projection and the end portion 2006 includes the depression. During such attachment, the bore 3008 may be co-aligned with the axis of symmetry of the shank 2000. However, note that the ball-detent mechanism is not required and other forms of attachment may be used. For example, the tip 4000 or the stopper 3000 may include the bore 3008 (e.g., a socket) having a non-circular shape (e.g., square, rectangle, pentagon, hexagon, teardrop, oval, triangle), which can be symmetrical or asymmetrical. For example, the non-circular shape includes at least one corner. The bore 3008 may be able to mate with a corresponding drive or driver (e.g., ¼ inch or ⅜ inch or others), whether powered (e.g., electric, pneumatic, hydraulic) or manual. As such, the tip 4000 or the stopper 3000 may be attached to the shank 2000 or vice versa. Note that the bore 3008 may be threaded in one direction (e.g., counterclockwise, clockwise) and, in such use case, the shank 2000 may be spun by the power tool 1500 in an opposite direction (e.g., clockwise, counterclockwise).

When the stopper 3000 is present, then the shank 2000 (e.g., the end portion 2006) can extend from the stopper 3000 (e.g., from the bore 3008) when the shank 3000 is attached with the tip 4000 (e.g., a ball-and-detent mechanism). The pair of outwardly extending portions terminate at the stopper 3000 (e.g., the outer surface 3004) such that the stopper 3000 extends between the pair of outwardly extending portions and the shank 2000 when the shank 2000 is attached with the tip 4000. As such, the pair of outwardly extending portions enable the tip 4000 to widen (e.g., flare) the open end portion 1508 of the tube 1500 by flaring until the stopper 3000 (e.g., the outer surface 3004) contacts the tube 1500 and the open end portion 1508 is converted to the open end portion 1510.

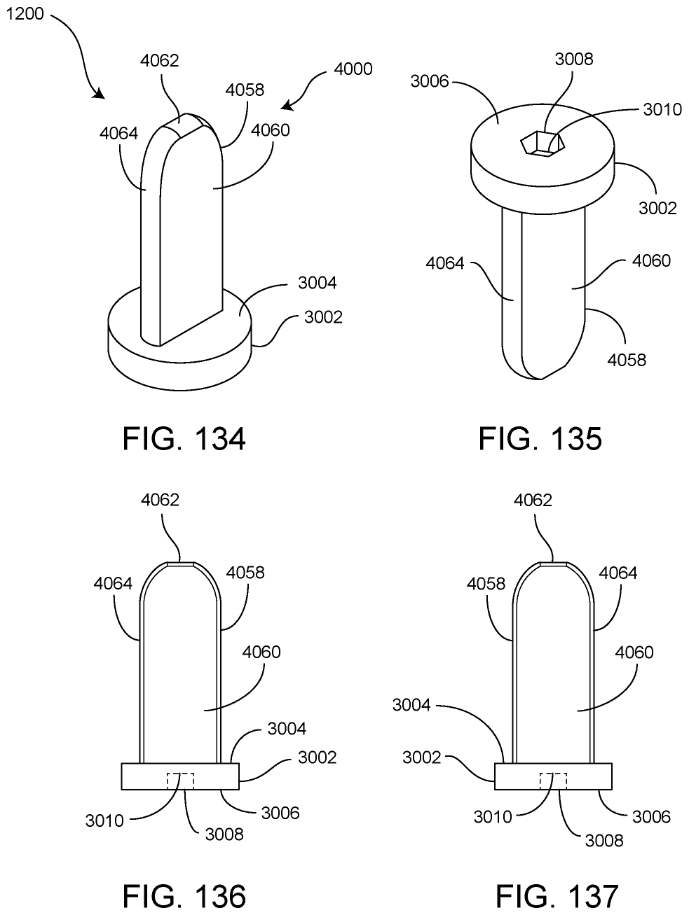

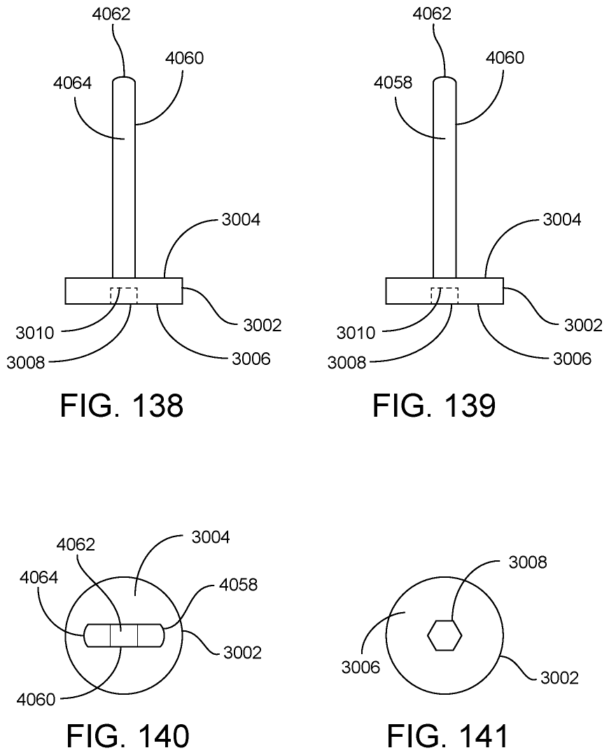

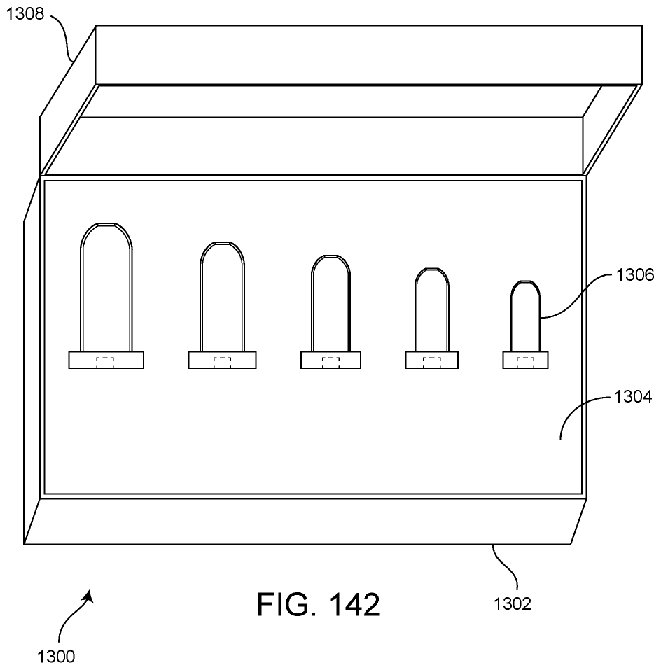

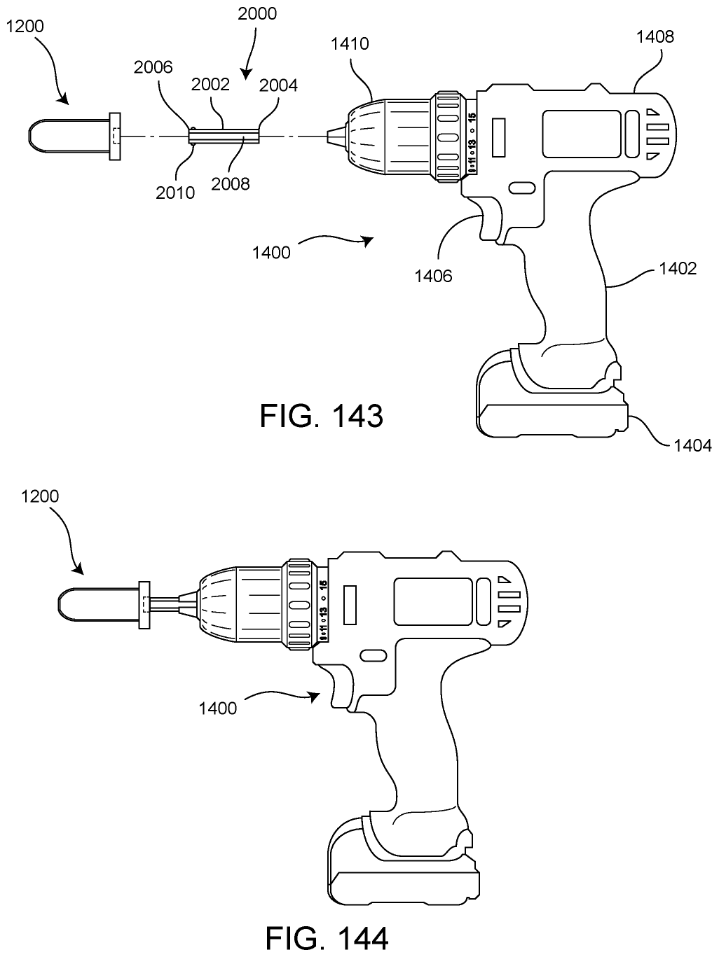

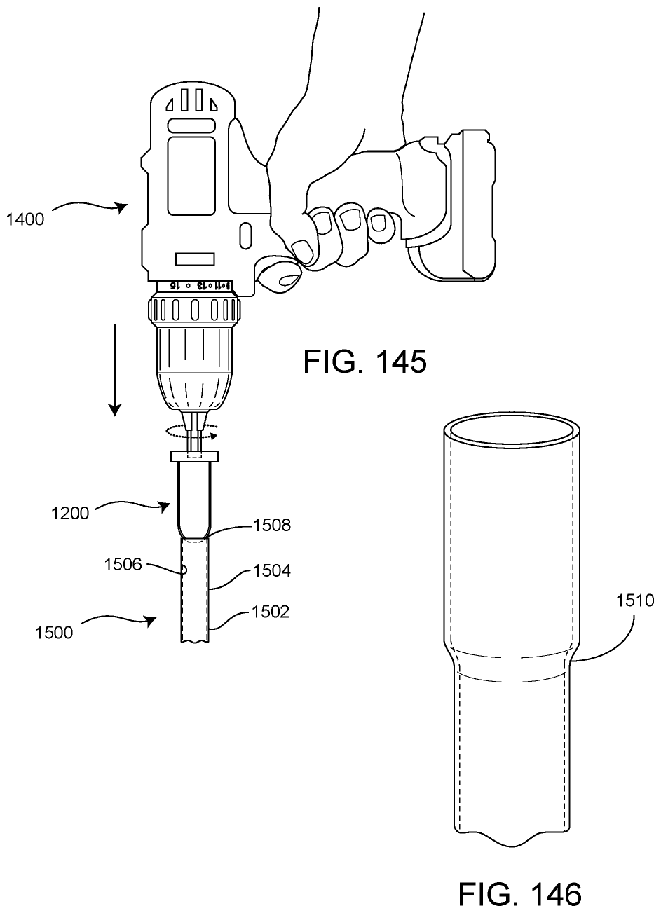

FIG. 134 to FIG. 141 show a bit according to this disclosure. FIG. 142 shows a container storing a set of bits arranged according to a set of sizes according to this disclosure. FIG. 143 to FIG. 144 show how a bit is secured to a chuck of a drill according to this disclosure. FIG. 145 to FIG. 146 show how a bit secured to a chuck of a drill is used to swage an open end of a tube according to this disclosure. In particular, a bit 1200 is structurally and functionally similar to the prior bits, manufactured similar to the prior bits, packaged similar to the prior bits, and operated similar to the prior bits. However, unlike the prior bits, the bit 1200 does not have the pair of outwardly extending portions. As such, the bit 1200 does not widen the open end portion 1508 by flaring. Instead, the bit 1200 widens the open end portion 1508 by swaging. This occurs based on the tip 4000 having the outer surfaces 4064 include a pair of rectilinear portions terminating the tip 4000 such that the pair of rectilinear portions enable the tip 4000 to widen (e.g., swage) the open end portion 1508 of the tube 1500 by swaging to convert the open end portion 1508 to appear as the open end portion 1510.

When the stopper 3000 is present, then the shank 2000 (e.g., the end portion 2006) can extend from the stopper 3000 (e.g., from the bore 3008) when the shank 3000 is attached with the tip 4000 (e.g., a ball-and-detent mechanism). The pair of rectilinear portions terminates at the stopper 3000 (e.g., the outer surface 3004) such that the stopper 3000 extends between the pair of rectilinear portions and the shank 2000 when the shank 2000 (e.g., the end portion 2006) is attached with the tip 4000 (e.g., via the bore 3008). As such, the pair of rectilinear enable the tip 4000 to widen (e.g., swage) the open end portion 1508 of the tube 1500 by swaging until the stopper 3000 (e.g., the outer surface 3004) contacts the tube 1500 (e.g., the open end portion 1510).

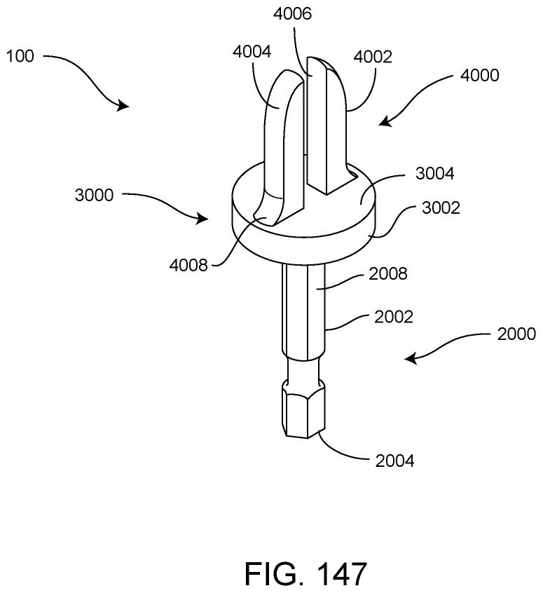

FIG. 147 shows a bit having a shank with a varying cross-section or width according to this disclosure. In particular, the shank 2000 has a varying cross-section or width between the end portion 2004 and the end portion 2006. The outer surface 2008 extending over the varying cross-section or width is flat or smooth and does not have the hexagonal cross-section, as shown in FIG. 1, although this is possible. The shank 2000 with the varying cross-section or width can be used in any bit, as disclosed herein.

Note that some tips may convert from a swage configuration to a flare configuration and vice versa, before spinning by the power tool 1500, via being telescoping sliding, one tip over another. The outer tip (e.g., a hollow tip) is a swaging tip and the inner tip is a flaring tip. The outwardly extending portion for flaring can elastically pop out (e.g., via a spring or another elastic member) from the inner tip when the outer tip is telescoping slid away from the shank 2000 to allow the outwardly extending portion to expand out (e.g., via a spring or another elastic member) and prevent from backward movement by a pair of fingers holding up the outer tip above the outwardly extending portion. Likewise, the outer tip can be telescoping slid back by retracting or pivotably folding the pair of fingers such that the outer tip slides over the outwardly extending portion and pushes that portion back into the inner tip.

Features (e.g., the shanks 2000, the tips 4000, the stoppers 3000, no stoppers 3000) described with respect to certain example embodiments can be combined and sub-combined in or with various other example embodiments. Also, different aspects or elements of example embodiments, as disclosed herein, can be combined and sub-combined in a similar manner as well. Further, some example embodiments, whether individually or collectively, can be components of a larger system, wherein other procedures can take precedence over or otherwise modify their application. Additionally, a number of steps can be required before, after, or concurrently with example embodiments, as disclosed herein. Note that any or all methods or processes, at least as disclosed herein, can be at least partially performed via at least one entity in any manner.

Example embodiments of this disclosure are described herein with reference to illustrations of idealized embodiments (and intermediate structures) of this disclosure. As such, variations from various illustrated shapes as a result, for example, of manufacturing techniques or tolerances, are to be expected. Thus, various example embodiments of this disclosure should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary, or be separately manufactured or connected, such as being an assembly or modules. Any or all elements, as disclosed herein, can be manufactured via any manufacturing processes, whether additive manufacturing, subtractive manufacturing, or other any other types of manufacturing. For example, some manufacturing processes include three dimensional (3D) printing, laser cutting, computer numerical control routing, milling, pressing, stamping, vacuum forming, hydroforming, injection molding, chiseling, lithography, casting, and so forth.

Various corresponding structures, materials, acts, and equivalents of all means or step plus function elements in various claims below are intended to include any structure, material, or act for performing the function in combination with other claimed elements as specifically claimed. Various embodiments were chosen and described in order to best disclose various principles of this disclosure and various practical applications thereof, and to enable others of ordinary skill in a pertinent art to understand this disclosure for various embodiments with various modifications as are suited to a particular use contemplated.

This detailed description has been presented for various purposes of illustration and description, but is not intended to be fully exhaustive or limited to this disclosure in various forms disclosed. Many modifications and variations in techniques and structures will be apparent to those of ordinary skill in an art without departing from a scope and spirit of this disclosure as set forth in various claims that follow. Accordingly, such modifications and variations are contemplated as being a part of this disclosure. Scope of this disclosure is defined by various claims, which include known equivalents and unforeseeable equivalents at a time of filing of this disclosure.

1. A bit comprising:
a shank configured to be spun; and
a tip configured to widen an open end portion of a tube by engaging thereaganst when the shank is spinning and the tip is inserted into the open end portion.

2. The bit of claim 1, wherein the tip comprises a first projection and a second projection, wherein the first projection and the second projection are spaced apart from each other such that an air gap is formed therebetween.

3. The bit of claim 2, wherein the first projection has a first inner surface, wherein the second projection has a second inner surface, wherein the first inner surface faces the second inner surface, wherein the aft gap extends between the first inner surface and the second inner surface.

4. The bit of claim 2, wherein the shank has an axis of rotation or an axis of symmetry, wherein the air gap is co-aligned with the axis of rotation or the axis of symmetry.

5. The bit of claim 2, further comprising:
a stopper, wherein the shank extends from the stopper; wherein each of the first projection and the second projection extends from the stopper such that the stopper extends between the air gap and the shank.

6. The bit of claim 5, wherein the first projection includes a first sloped portion merging into the stopper, wherein the second projection includes a second sloped portion merging into the stopper, wherein the first sloped portion and second sloped portion extend away from each other such that the air gap extends therebetween and the tip widens the open end portion of the tube by flaring until the stopper contacts the tube.

7. The bit of claim 5, wherein the first projection includes a first rectilinear portion terminating at the stopper, wherein the second projection includes a second rectilinear portion terminating at the stopper, wherein the first rectilinear portion and second rectilinear portion extend parallel to each other such that the air gap extends therebetween and the tip widens the open end portion of the tube by swaging until the stopper contacts the tube.

8. The bit of claim 5, wherein the stopper is a disc,

9. The bit of claim 8, wherein the disc is circular.

10. The bit of claim 5, wherein the stopper includes a corner.

11. The bit of claim 1, wherein the tip includes a plate having a first outwardly extending portion, a second outwardly extending portion, a first inwardly extending portion starting where the first outwardly extending portion terminates, and a second inwardly extending portion starting where the second outwardly extending portion terminates, wherein the first inwardly extending portion extends between the shank and the first outwardly extending portion, wherein the second inwardly extending portion extends between the shank and the second outwardly extending portion, wherein the first outwardly extending portion and the second outwardly extending portion enable the tip to widen the open end portion of the tube by flaring.

12. The bit of claim 11, further comprising:
a stopper, wherein the shank extends from the stopper, wherein the first inwardly extending portion terminates at the stopper such that the first inwardly extending portion extends between the first outwardly extending portion and the stopper, wherein the second inwardly extending portion terminates at the stopper such that the second inwardly extending portion extends between the second outwardly extending portion and the stopper, wherein the first outwardly extending portion and the second outwardly extending portion enable the tip to widen the open end portion of the tube by flaring.

13. The bit of claim 12, wherein the stopper is a disc.

14. The bit of claim 13, wherein the disc is circular,

15. The bit of claim 12, wherein the stopper includes a corner.

16. (canceled)

17. The bit of claim 11, wherein the shank has an axis of rotation or an axis of symmetry, wherein the axis of rotation or the axis of symmetry extends through the plate between the first inwardly extending portion and the second inwardly extending portion.

18. The bit of claim 1, wherein the tip includes a plate having a first rectilinear portion, a second rectilinear portion, a first inwardly extending portion starting where the first rectilinear portion terminates, and a second inwardly extending portion starting where the second rectilinear portion terminates, wherein the first inwardly extending portion extends between the shank and the first rectilinear portion, wherein the second inwardly extending portion extends between the shank and the second rectilinear portion, wherein the first rectilinear portion and the second rectilinear portion enable the tip to widen the open end portion of the tube by swaging.

19. The bit of claim 18, further comprising:
a stopper, wherein the shank extends from the stopper, wherein the first inwardly extending portion terminates at the stopper such that the first inwardly extending portion extends between the first rectilinear portion and the stopper, wherein the second inwardly extending portion terminates at the stopper such that the second inwardly extending portion extends between the second rectilinear portion and the stopper, wherein the first rectilinear portion and the second rectilinear portion enable the tip to widen the open end portion of the tube by swaging.

20. The bit of claim 19, wherein the stopper is a disc.

21. The bit of claim 20, wherein the disc is circular.

22. The bit of claim 19, wherein the stopper includes a corner.

23. The bit of claim 18, wherein the shank has an axis of rotation or an axis of symmetry, wherein the axis of rotation or the axis of symmetry extends through the plate between the first inwardly extending portion and the second inwardly extending portion.

24. The bit of claim 1, wherein the shank has an axis of rotation or an axis of symmetry, wherein the axis of rotation or the axis of symmetry extends through the tip, wherein the tip is asymmetrical to the axis of rotation or the axis of symmetry.

25-31. (canceled)

32. The bit of claim 1, wherein the tip has a sidewall that is conical in extension and narrows in width away from the shank.

33-41. (canceled)

42. The bit of claim 1, wherein the shank is directly extending from the tip without having a stopper extend between the shank and the tip.

43-44. (canceled)

45. The bit of claim 1, wherein the shank and the tip are attachable to each other.

46-64. (canceled)

65. A method comprising:
sending a bit to a user, wherein the bit includes a shank and a tip; and
instructing the user to:
spin the shank; and
insert the tip into an open end portion of a tube while the shank is spinning such that the tip widens the open end portion by engaging thereagainst.
